(19) United States
(12) Patent Application Publication
(10) Pub. No.: US 2005/0256790 A1
(43) Pub. Date: Nov. 17, 2005

(54) System and method of reducing the cost of raising capital

(76) Inventor: Timothy D. Hogan, Harbor Springs, MI (US)

Correspondence Address: Jeffrey H. Canfield;Bell, Boyd & Lloyd LLC, P.O. Box 1135, Chicago, IL, 60690-1135, US

(21) Appl. No.: 10/843,838

(22) Filed: May 12, 2004

(51) Int. Cl. G06F 17/60

(52) U.S. Cl. 705/35

(57) ABSTRACT

The present invention is related to a system and method of reducing the cost of raising capital for a business or enterprise. The invention provides interlinked template worksheets and all associated documents necessary to complete a capitalization plan to present to investors. The input data entered by the enterprise is shared with other worksheets and is used to generate other data to substantially complete the worksheets and determine a capital need. The invention further enables the enterprise to efficiently test an infinite number of deal structures to meet the determined capital need and to provide a desirable investment outcome. An investment outcome such as an internal rate of return is based on the one or more deal structures employed in the capitalization plan. Once the enterprise has determined the optimal parameters and timing of the execution of the deal structures, the invention provides substantially all of the template documents necessary to complete the capitalization plan to market to investors.

### BACKGROUND OF THE INVENTION

The present invention relates to a system and a method of reducing the cost of raising capital. More specifically, the present invention provides a system and a method of developing a capitalization plan, structuring deals, company valuation, creating and pricing securities, and producing securities offering documentation using interconnected worksheet templates.

Raising capital for start-up, early stage, and even seasoned businesses can be an extremely complex and expensive endeavor. The mechanisms and deal structures for attracting outside funding are myriad, ranging from single source “angel” investors to full blown public securities offerings. All of the various capitalization models have distinct advantages and disadvantages for the various parties involved. For example, the entrepreneur, start-up, early stage, or seasoned business organization (hereafter “the enterprise”) will want to receive funds with as few strings attached as possible in order to grow the business as they see fit. Investors, on the other hand, will typically seek some level of control in order to protect their investment, and will seek a deal structure where they can maximize the return on their investment if and when the business succeeds, or minimize the loss if it fails.

Determining which capitalization model is most appropriate for a particular start-up and generating the financial and legal documentation to implement the selected model can be a significant financial drain on the limited resources of a fledgling start-up. Typically, investment bankers, accountants and lawyers are hired to provide guidance in selecting the capitalization model and preparing the documentation for implementing it. These financial professionals may investigate multiple capitalization scenarios in order to determine the best capitalization model prior to preparing final documentation for implementing the capitalization model selected. This can be a laborious and time-consuming process. Accountant's and lawyer's time is expensive, and the adoption of a particular capitalization model and the documentation to support it can be a significant expense in the process of raising capital.

In the do-it-yourself spirit common to many entrepreneurs, an enterprise may desire to select a capitalization model and prepare the supporting documentation itself, with the accountants and lawyers only signing off on the final documents. In other words, if the enterprise can select an appropriate capitalization plan on its own, and prepare the supporting documentation itself, the professional fees associated with raising capital can be significantly reduced. Even if the start-up only performs part of the necessary work, the professionals can complete the work in much less time than if they were starting from scratch. Unfortunately, most start-ups do not have the expertise and experience in accounting, law and finance to perform these tasks efficiently and accurately enough to assure themselves that the selected capitalization model is the most appropriate, and that the documentation prepared to support it are prepared correctly. Thus, start-ups are forced into expending significant amounts of their limited resources in an attempt to access capital markets to increase their resources.

In all, the production of the pro form a financial projections for the enterprise company and the creation of the deal structures of its capitalization plan represent approximately 30% of the actual work and cost involved in the entire capital raising process. The production of the text body of the securities offering document constitutes about 10% (assuming a written business plan has been prepared). The solicitation and sales of securities constitutes about 50% of the process. And the compliance follow-up requirements constitute another 10% of the actual work and cost involved.

Raising capital, therefore, is an extremely complex and expensive legal, accounting, and investment banking process. The inability to overcome these preliminary cost-prohibitive hurdles can prevent an enterprise from taking its first step to introducing a potentially valuable technology, process, product, or needed service into the marketplace. A need, therefore, exists to enable an enterprise to raise sufficient seed capital in a private placement securities offering to create an opportunity for the entrepreneur to procure substantial amounts of developmental or expansion capital.

### SUMMARY OF THE INVENTION

The present invention provides a method and system for reducing the costs of raising capital for a business enterprise. The present invention allows the enterprise to reduce the amount of fees that would normally be paid to lawyers, accountants, investment bankers and other professionals by enabling the enterprise to substantially develop and implement a capitalization plan on its own.

According to the invention, a software package is provided to the enterprise. The software package allows the enterprise to prepare a capitalization plan that is substantially complete and which requires only a minimal amount of review and modification by financial professionals in order to ensure the accuracy of the various documents, and to ensure proper regulatory compliance.

Some of the steps necessary to develop and implement a capitalization plan provided by the present invention include enterprise valuation, deal structuring, securities creation, pricing the securities and producing securities offering documentation from interconnected worksheets using spreadsheet and word processing software. The invention will be described herein in the context of preparing securities offering documents to be presented to investors or filed with the Securities Exchange Commission (SEC) in the process of seeking funding for an enterprise. It should be appreciated, however, that the invention can be used to prepare any documents associated with raising capital for an enterprise at any stage of its existence which include, but are not limited to, private and public securities offerings.

The invention can be applied and used in the context of capitalizing other initiatives such as a real estate development project. Various applications of the present invention can have substantially similar systematic processes and methodologies, but vary in timeframe, formulae, and categories. In applying the present invention to a real estate development project, for example, the worksheets can be monthly for three years, which consolidate into seven more years for a ten-year financial projection. The formulas can also be different due to the nature of different taxation, inventory (Housing Units) carrying costs, cash flows dedicated to lower construction lines of credit, etc.

According to an embodiment of the invention, a method of reducing the cost of raising capital is provided. The method includes providing a mechanism whereby an enterprise can test various deal structures to determine at least one deal structure that is optimal for the circumstances of the enterprise and generating at least one document supporting the selected deal structure and/or security form. The method can include associating a plurality of interconnected worksheets with the document, wherein data input into at least one worksheet is used to determine information provided in another document.

In another embodiment of the present invention, a method of producing securities offering documentation is provided. The method includes providing a plurality of template documents at least one of which includes variable data or information to be calculated or determined. At least one worksheet is associated with the template documents on which the further step of gathering information from the entrepreneur occurs to calculate or determine the variable data or information within the template documents. The variable data or information can include an estimated capital need and at least one form of security to address the capital need. In one embodiment, an internal rate of return to an investor is determined for each security form. This step includes determining a deal structure which addresses the capital need and provides the optimal balance of risk and internal rate of return to the investor. Applying the deal structure to the capital need includes calculating the variable data of the template document based on the determined deal structure. Finally, the method includes the step of selectively presenting an investor with a securities offering document incorporating the applied deal structure according to a perceived level of risk tolerated by the investor.

A feature of the invention provides a method of pricing equity securities and valuing the enterprise according to the equity pricing. The method includes assigning a random number of shares of common stock to be issued and pricing those shares according to the Estimated Net Income and an adjusted price-to-earnings ratio for the enterprise. A further step includes determining the total number of outstanding common stock shares after the sale of common stock and then multiplying the total number of outstanding common stock shares by the price of those shares.

The present invention further encompasses a system for producing securities offering documentation. The system includes a processor operable to run a spreadsheet template in a spreadsheet software program. The spreadsheet template is adapted to receive input data from a user to determine a capitalization need. The spreadsheet template is further adapted to calculate an internal rate of return based on the capitalization need and the terms of a deal structure. The system is configured to update linked input data based on changes made to the terms of the deal structure or other input data. The system is also configured to determine the terms of the deal structure that meet the capitalization need and provide an attractive prototype securities offering based on an optimal balance of risk and internal rate of return to the investor. Once the deal structure is determined, variable data within the template document can be completed based on the determined deal structure. The user may then present an investor with a securities offering document for each optimized deal structure, allowing the entrepreneur to selectively present the securities offering documents that correspond to a level of risk tolerated by the investor.

A further method of the invention includes creating a capitalization plan. The method comprises the steps of providing annualized revenue assumptions. The annualized revenue assumptions include predictions of the revenue from sales of goods and/or services each fiscal year. Another step of the method of creating a capitalization plan includes calculating the annualized cost of goods sold to determine a gross profit per fiscal year based on the revenue assumptions and the cost of goods sold. The annual general and administrative expenses are calculated to determine a net operating profit or loss per fiscal year based on the gross profit and the general and administrative expenses. A further step includes calculating the annualized costs, if any, of capitalized assets per fiscal year and then calculating a depreciation or amortization for each capitalized asset based on the value of each capitalized asset and the number of years over which the capitalized asset is depreciated or amortized. The total operating expenses are calculated based on the general and administrative expenses and the depreciation or amortization. A capitalization amount of equity securities sufficient to offset any negative end of the year cash and equivalents is tested. The equity securities include a number of equity shares and a price of each equity. A further step includes determining the value of the enterprise based on an estimated net income, an estimated annual earnings growth rate and a valuation of equity securities. The method then includes the step of presenting at least one form of security to provide the capitalization amount, wherein said form is selected from a group consisting of notes, bonds, common stock, preferred stock, participating preferred stock, notes with an equity kicker and royalty financing contracts. An internal rate of return is calculated based on the forms of the securities used to provide the capitalization amount, and it is determined if the internal rate of return based on the calculated values is desirable. If the internal rate of return is desirable, the calculated and input data are transferred to a securities offering document.

By employing the present invention, a user is able to test the private capital markets with prototypes of securities offerings, produce its own securities offering documents for private placement, and successfully raise capital for the start-up, early stage, or seasoned, privately-held enterprise. Among the advantages of the present invention is that input data which determines the terms of a deal structure, such as the price per share of equity common stock, preferred stock, the royalty percentage of the royalty financing contracts, or the interest rate of a note may be altered. By re-calculating variables in the capitalization plan which are dependent on the new data, the user is able to rapidly and efficiently create new capitalization plans based on the new data. Another advantage includes being able to test many different prototypes of securities offerings to determine the terms of an acceptable deal structure and incorporate those terms into new capitalization plans to generate securities offering documentation which may be more appealing to investors. An additional advantage of the present invention includes converting relatively complex and expensive legal, accounting, and investment banking processes into a relatively inexpensive, easy-to-use software template that allows virtually any entrepreneur or enterprise to compete for capital or to engage in other sophisticated capitalization and valuation processes, such as franchising the entrepreneur's companies, operations, business acquisitions, business divestitures, etc. A further advantage is that completing the production of the enterprise's securities offering documents as provided in the invention will create in the user an understanding of the details of the capitalization plan and will generate in the investor a heightened level of trust and confidence in the ability of the entrepreneur to handle the task of building a profitable enterprise.

Additional features and advantages of the present invention are described in, and will be apparent from, the following Detailed Description of the Invention and the figures.

### BRIEF DESCRIPTION OF THE FIGURES

FIG. 1 is a flowchart illustrating a method for reducing the costs of raising capital for an enterprise.

FIG. 2 is a diagram illustrating a linked spreadsheet template for a Pro Form a Income Statement Company and Equity Valuation Worksheet.

FIG. 3 is a diagram illustrating a linked spreadsheet template for a Pro Form a Statement Of Operations.

FIG. 4 is a diagram illustrating a linked spreadsheet template for a Pro Form a Statement Of Cash Flows.

FIG. 5 is a diagram illustrating a linked spreadsheet template for a Pro Form a Balance Sheet.

FIG. 6 is a diagram illustrating a linked spreadsheet template for a Pro Form a Depreciation Schedule.

FIG. 7 is a diagram illustrating a linked spreadsheet template for a Sources And Uses Statement.

FIG. 8 is a diagram illustrating a linked spreadsheet template for a Pro Form a Internal Rate Of Return Statement.

FIG. 9 is a diagram illustrating formulae of a linked spreadsheet template for the Pro Form a Income Statement Company and Equity Valuation Worksheet of FIG. 2.

FIG. 10 is a diagram illustrating formulae of a linked spreadsheet template for the Pro Form a Statement Of Operations of FIG. 3.

FIG. 11 is a diagram illustrating formulae of a linked spreadsheet template for the Pro Form a Statement Of Cash Flows of FIG. 4.

FIG. 12 is a diagram illustrating formulae of a linked spreadsheet template for the Pro Form a Balance Sheet of FIG. 6.

FIG. 13 is a diagram illustrating formulae of a linked spreadsheet template for the Pro Form a Depreciation Schedule of FIG. 6.

FIG. 14 is a diagram illustrating formulae of a linked spreadsheet template for the Sources And Uses Statement of FIG. 7.

FIG. 15 is a diagram illustrating formulae of a linked spreadsheet template for the Pro Form a Internal Rate Of Return Statement of FIG. 8.

FIG. 16 is a diagram illustrating the Capitalization portion of a linked spreadsheet template for a Pro Form a Income Statement Company and Equity Valuation Worksheet.

FIG. 17 is a diagram illustrating a linked spreadsheet template for a Pro Form a Statement Of Cash Flows.

FIG. 18 is a diagram illustrating the Capitalization portion of a linked spreadsheet template for a Pro Form a Income Statement Company and Equity Valuation Worksheet.

FIG. 19 is a diagram illustrating a linked spreadsheet template for a Pro Form a Statement Of Cash Flows.

FIG. 20 is a diagram illustrating the Capitalization portion of a linked spreadsheet template for a Pro Form a Income Statement Company and Equity Valuation Worksheet.

FIG. 21 is a diagram illustrating a portion of a linked spreadsheet template for a Pro Form a Income Statement Company and Equity Valuation Worksheet.

FIG. 22 is a diagram illustrating a portion of a linked spreadsheet template for a Pro Form a Income Statement Company and Equity Valuation Worksheet.

FIG. 23 is a diagram illustrating a linked spreadsheet template for a Pro Form a Internal Rate Of Return Statement.

FIG. 24 is a diagram illustrating a linked spreadsheet template for a Pro Form a Statement Of Operations.

FIG. 25 is a diagram illustrating a linked spreadsheet template for a Pro Form a Statement Of Cash Flows.

FIG. 26 is a diagram illustrating a linked spreadsheet template for a Pro Form a Balance Sheet.

FIG. 27 is a diagram illustrating one embodiment of a final version of a Pro Form a Income Statement Company and Equity Valuation Worksheet.

### DETAILED DESCRIPTION OF THE INVENTION

The present invention provides a method and system for reducing the costs of raising capital for a business. The present invention is especially well suited for start-up businesses and entrepreneurs whose resources for raising capital are limited. Employing the methods and systems of the present invention, the small business/start-up/entrepreneur (“the enterprise”) can perform many of the steps necessary to develop and implement a capitalization plan substantially on its own, thereby reducing the amount of fees that would normally be paid to lawyers, accountants, investment bankers and other professionals. This can result in significant savings to the enterprise and allow a capitalization plan to be developed and implemented which could otherwise be cost-prohibitive. The invention can be applied and used in the context of capitalizing any initiative desired by the enterprise by manipulating timeframes, formulae, and/or categories of data. In applying the present invention to a real estate development project, for example, the worksheets can include monthly entries for three years, which consolidate into seven more years for a ten-year financial projection. The formulas can also be changed due to the nature of different taxation, inventory (Housing Units) carrying costs, cash flows dedicated to lower construction lines of credit, etc.

According to the invention, a software template package is provided to the enterprise. The software template package is designed to develop a realistic and appropriate capitalization plan for the enterprise and to generate the necessary documentation for implementing the plan. The invention does not necessarily eliminate the need for the services of lawyers, accountants, investment bankers and the like, but, it can assist the enterprise in performing much of the background work normally performed by such professionals. The invention allows the enterprise to present a capitalization plan that is substantially complete and which requires only a minimal amount of review and modification by the financial professionals in order to ensure the accuracy of the various documents, and to ensure proper regulatory compliance.

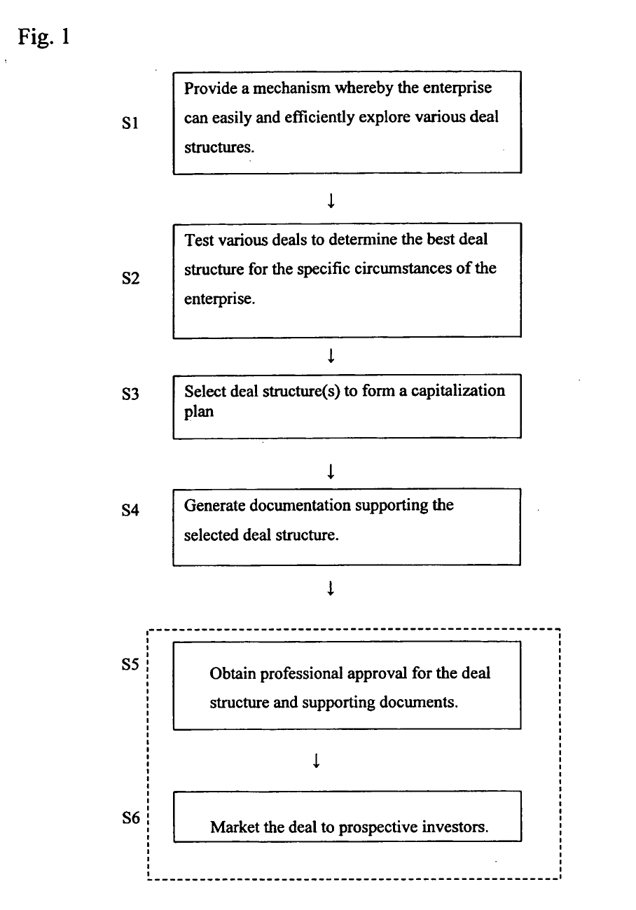

A broad outline of a method for reducing the costs of raising capital for an enterprise is shown in the flow chart of FIG. 1. The first step S1 is to provide a mechanism to the enterprise whereby the enterprise can easily and efficiently explore and evaluate various capitalization plans. Such a mechanism allows the enterprise to test various deal structures within a comprehensive capitalization plan in step S2 to determine the best deal structure(s) for raising capital considering the unique circumstances of the enterprise. At step S3, various deal structures are selected for developing an overall capitalization plan for funding the enterprise. At step S4, the mechanism provided in step S1 is used to produce supporting documentation for the deal structures comprising the capitalization plan. The enterprise may then take the generated documents to various financing professionals, as provided in step S5, to ensure their accuracy and regulatory compliance, as well as to seek additional advice on refining the capitalization plan or selecting a better plan. The final step, S6, is to market the various investment deals in the capitalization plan to the investment community in order to raise the desired funds to support the enterprise. Steps S5 and S6 are shown as dashed lines because they are steps that may be performed by the enterprise, independent of the mechanism provided for exploring various deal structures and generating the capitalization plan.

According to an embodiment of the invention, a software template package is provided to the enterprise for evaluating investment deal structures. The software template package includes a number of inter-linked or interconnected worksheets or templates for preparing pro form a financial projections as well as document templates for preparing notes to the pro formas and private placement memoranda for marketing the various investment deals that will form a part of the enterprise's capitalization plan. The worksheets comprise pro form a financial projections which meet Generally Accepted Accounting Procedures (GAAP) for privately held businesses. The pro form a financial projections serve as the basis for the overall capitalization plan and the deal structures that will be implemented by the enterprise to raise capital. The pro form a financial projections also form the foundation for other documents such as private placement memoranda that the enterprise will need to raise capital. The worksheets include sample templates for developing a capitalization plan for a hypothetical enterprise. Once a user has stepped through an example for generating the capitalization plan for the hypothetical enterprise, the user may alter and save the sample templates to generate pro form a financial projections and develop a capitalization plan that fits the requirements of his or her enterprise. The enterprise may use the pro form a financial projections and the corresponding private placement memoranda as “red herring” documents to test the waters of the investment markets, as well as for securities offerings, SEC filings and other state and federal filings.

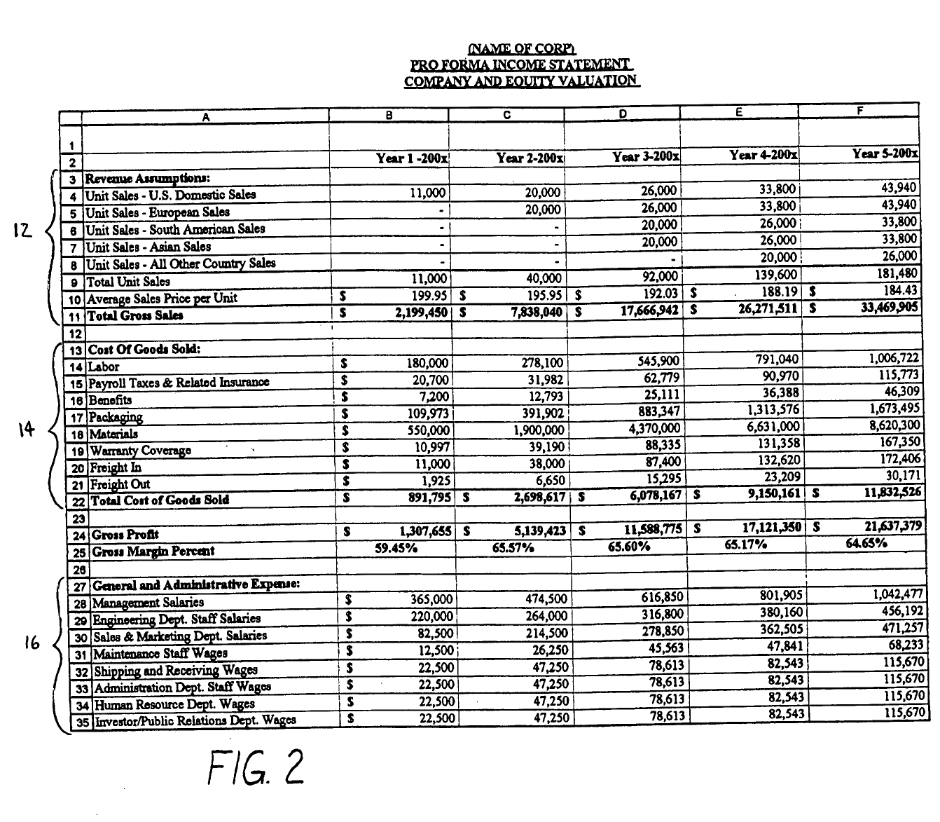

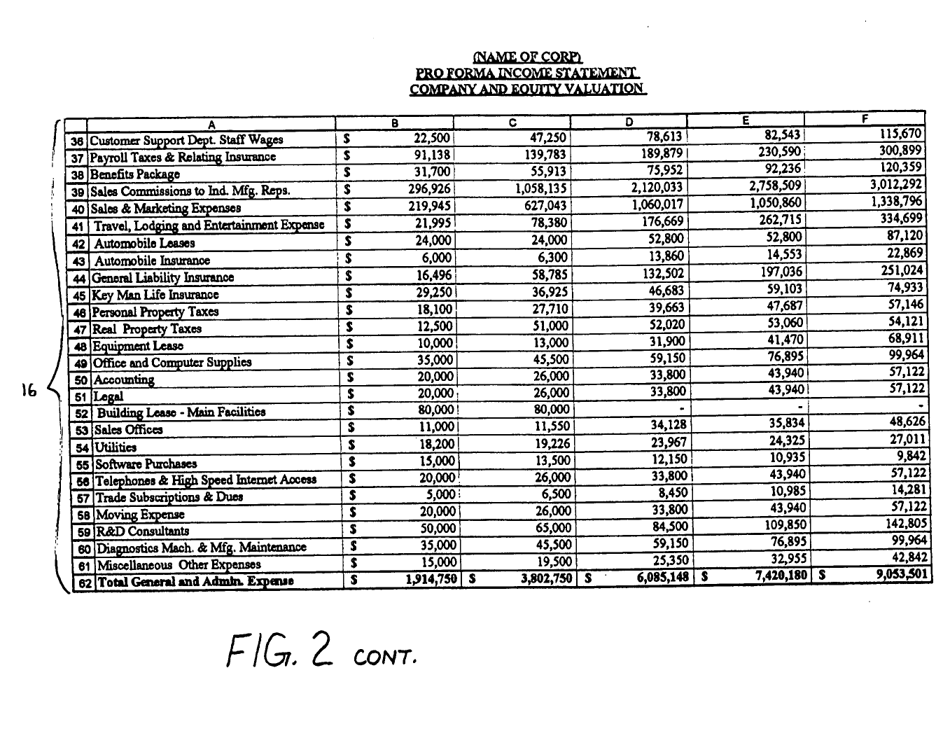

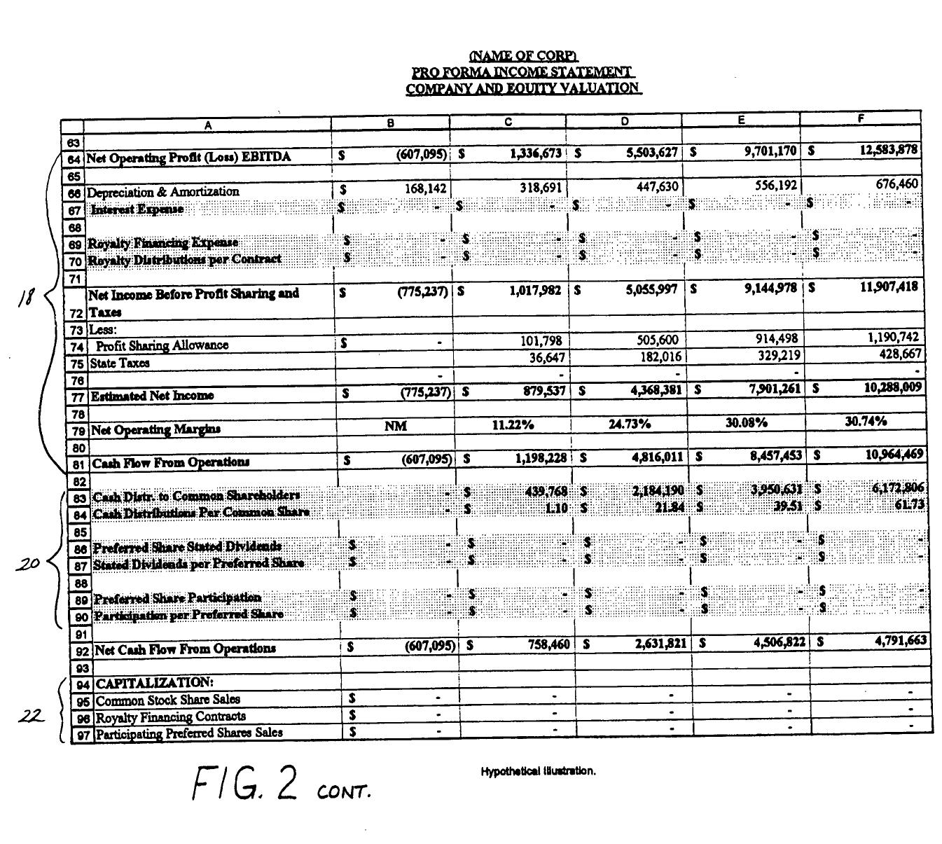

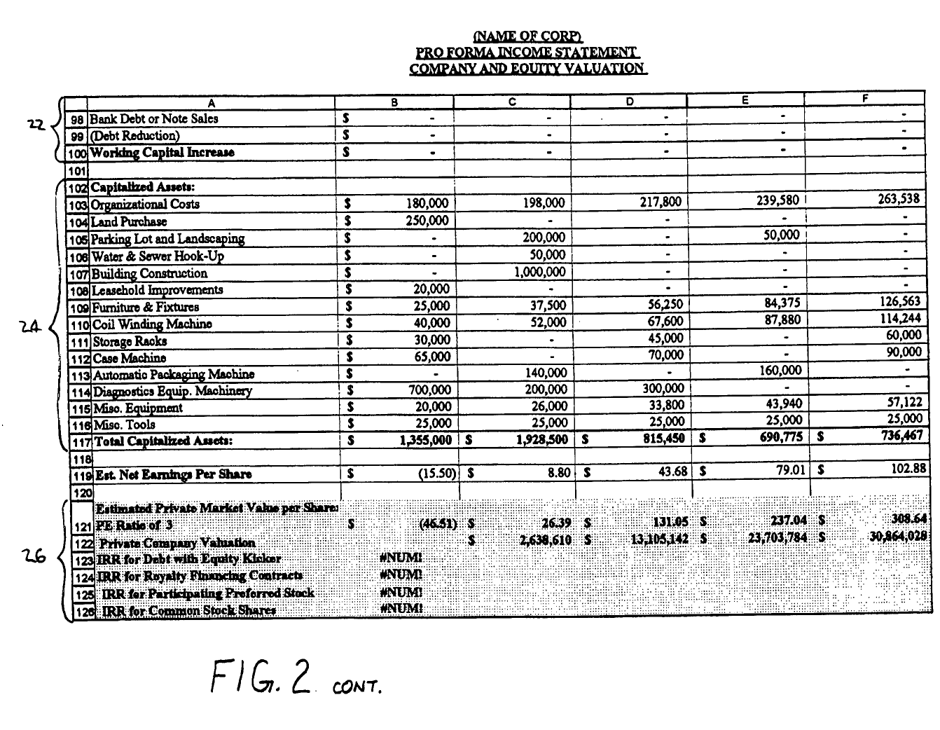

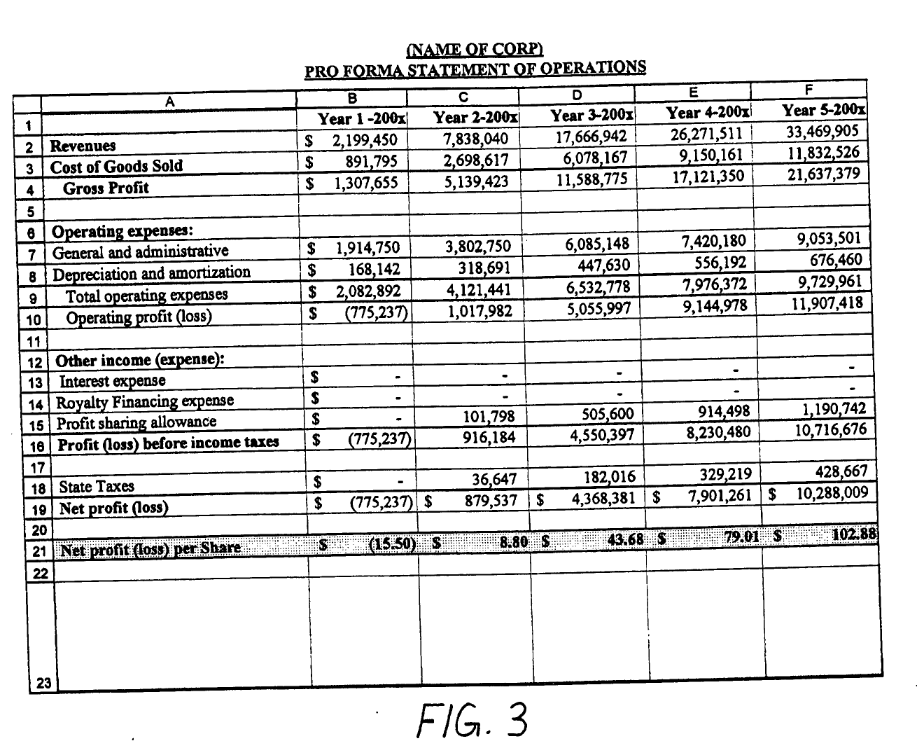

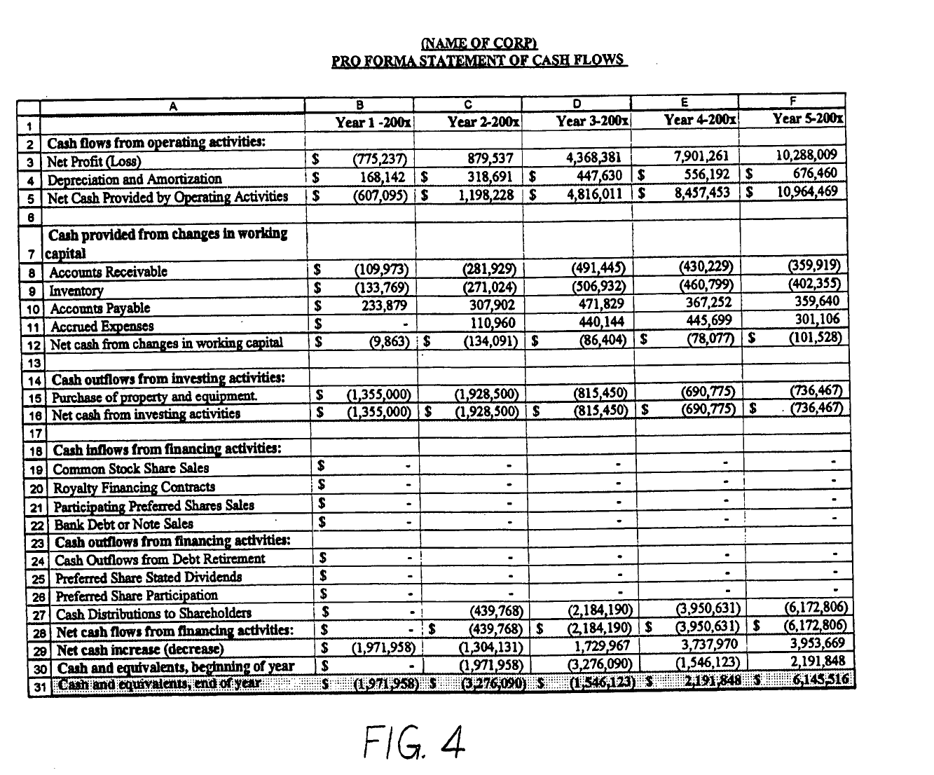

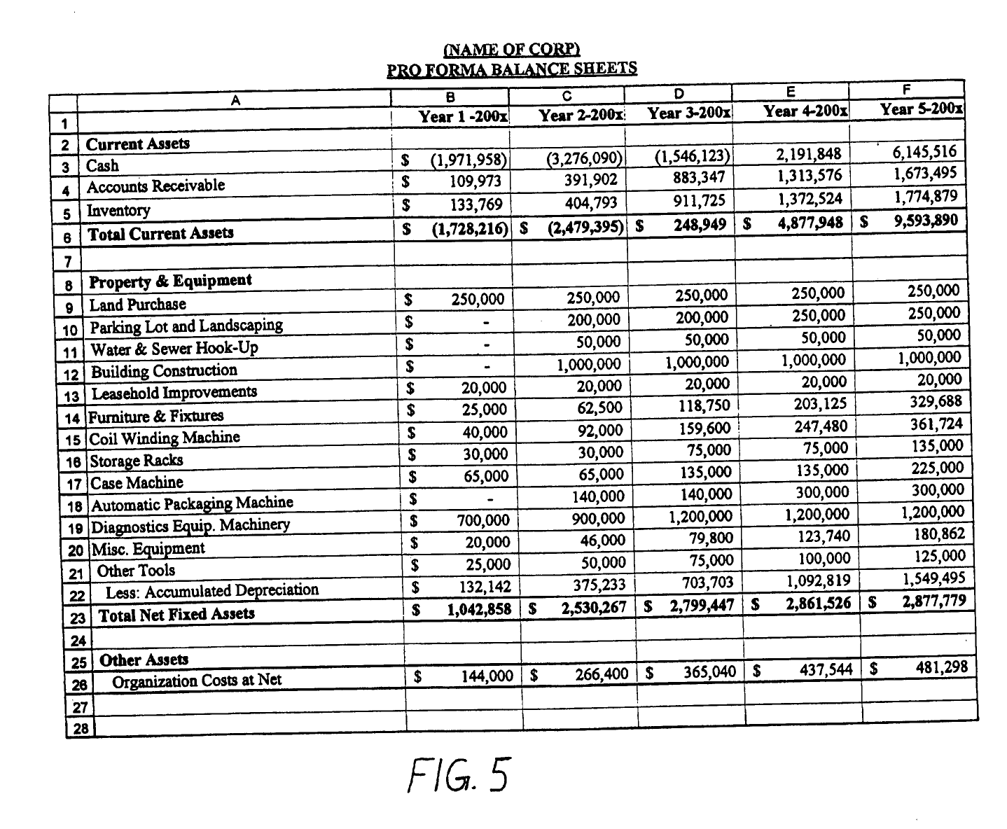

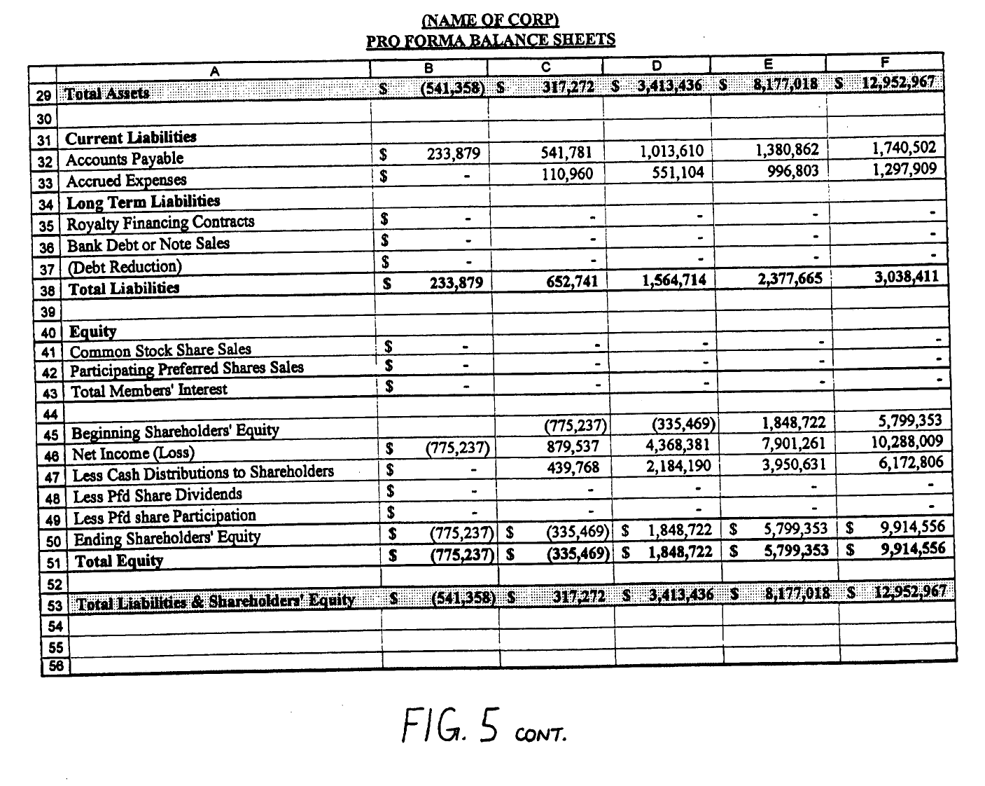

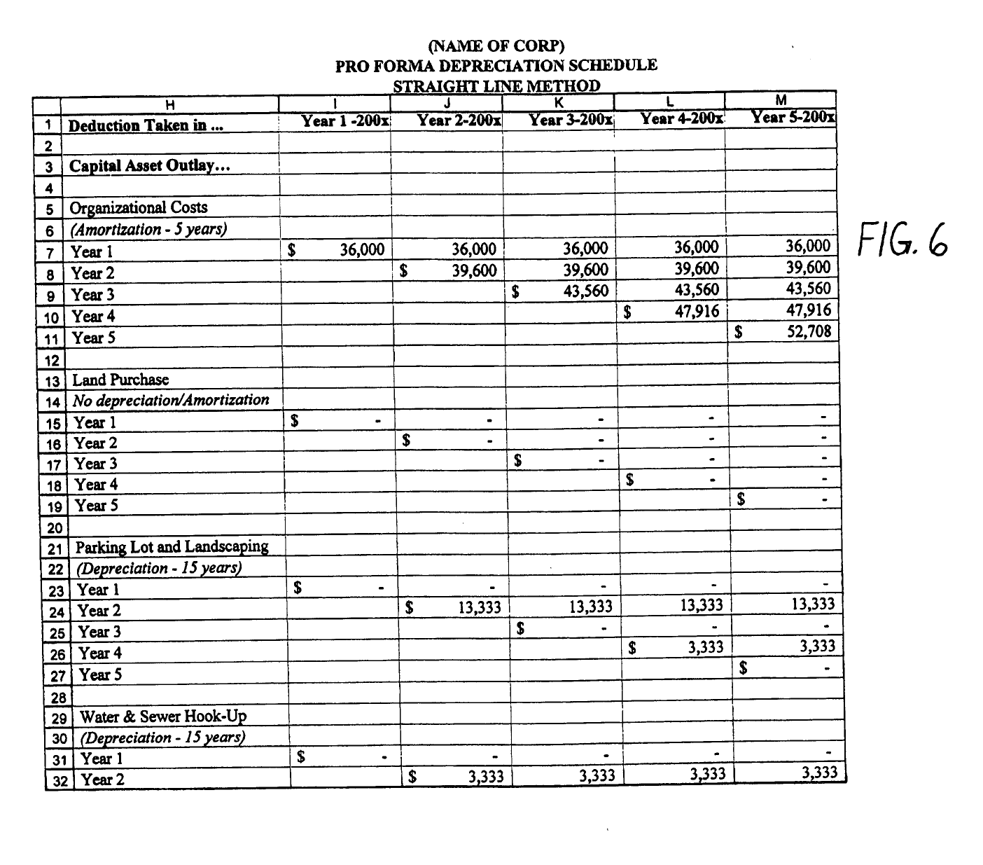

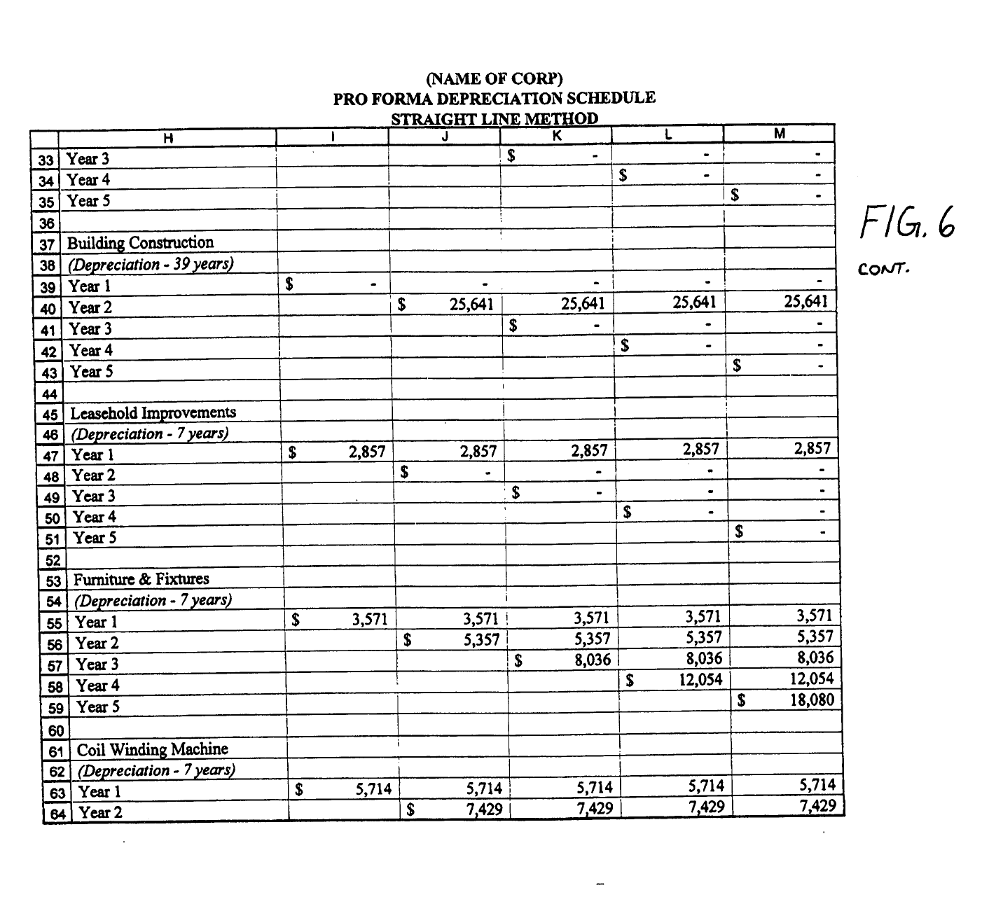

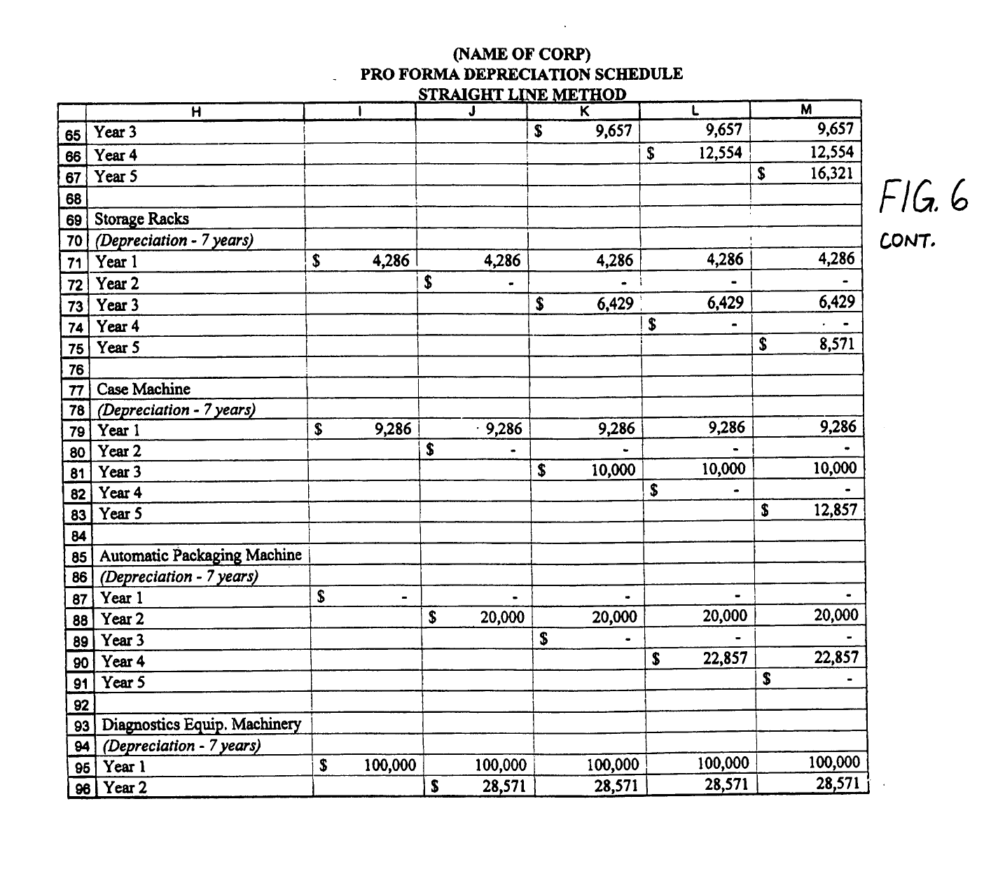

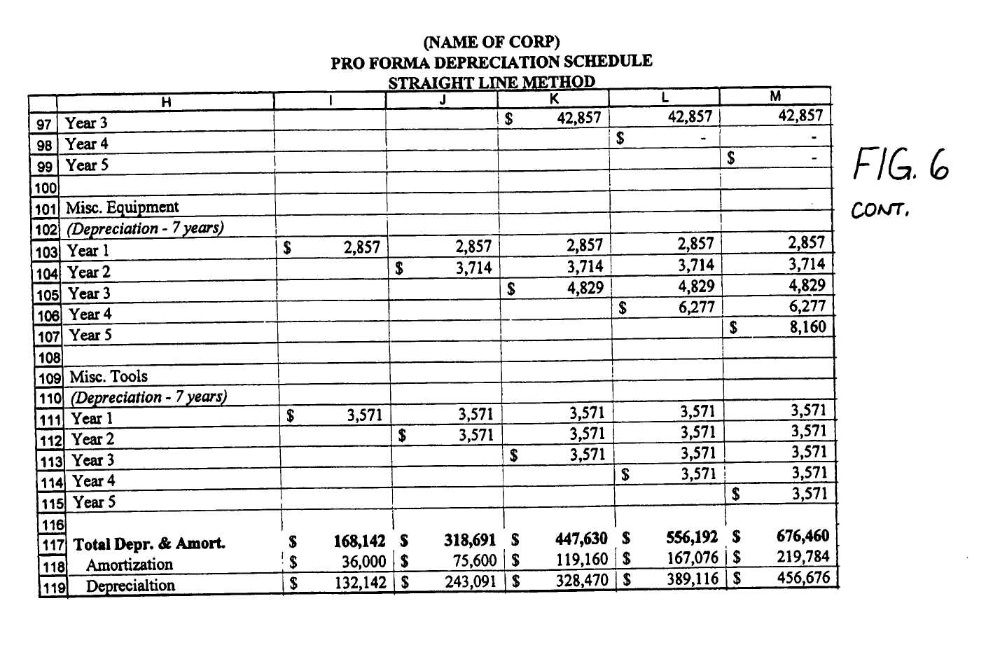

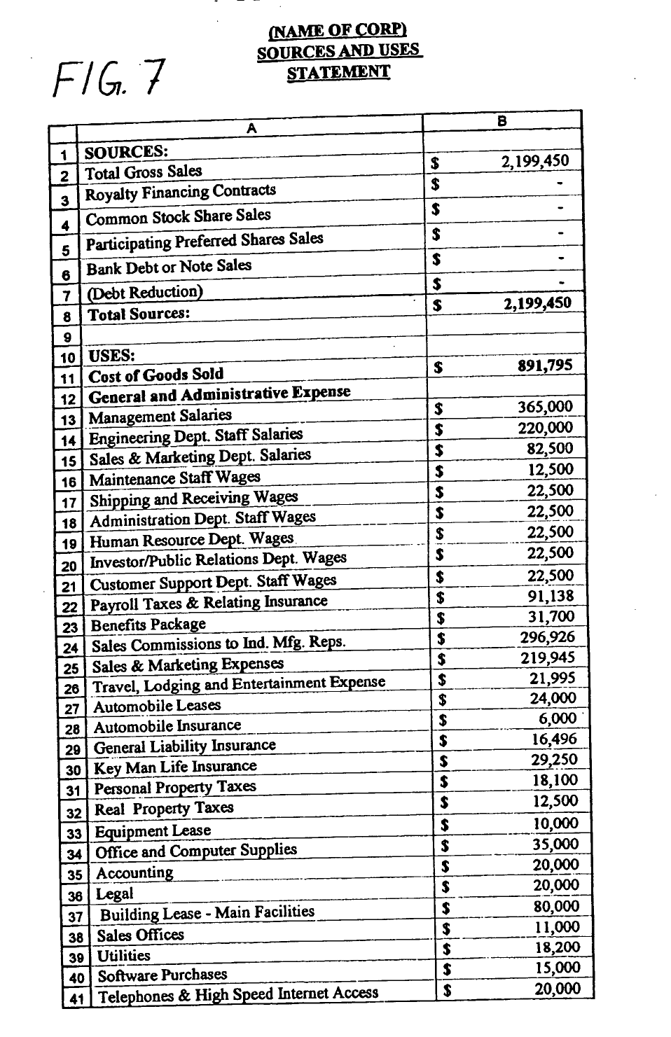

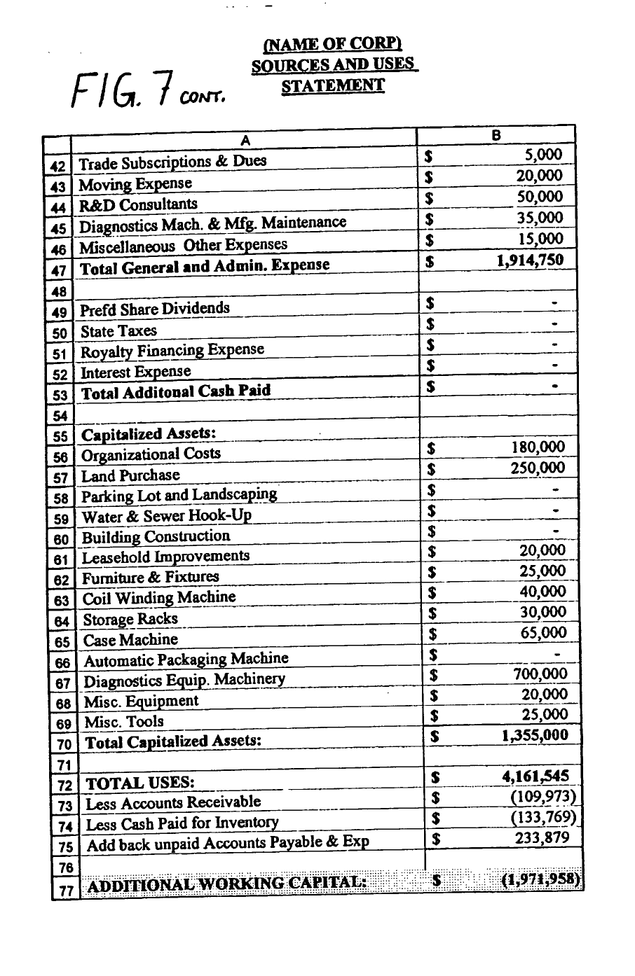

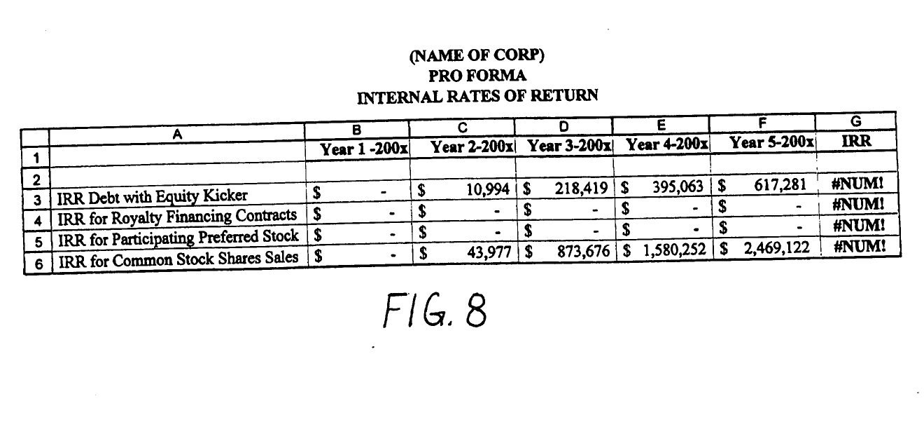

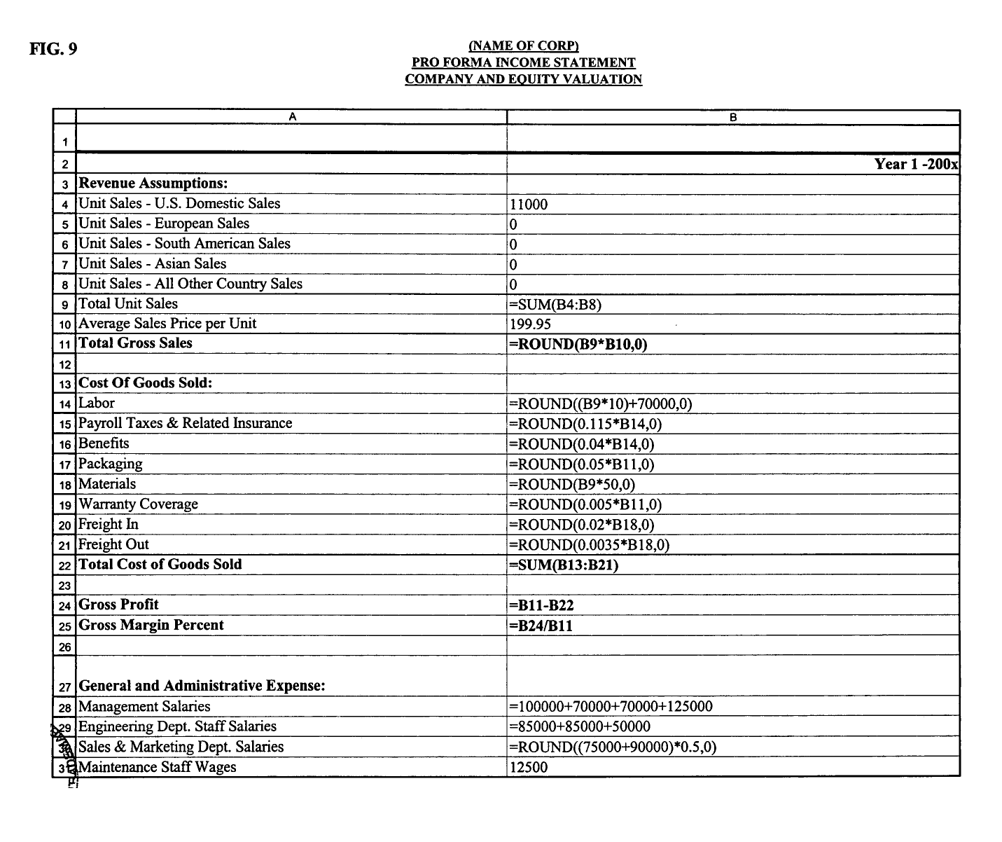

In an embodiment of the invention, the pro form a financial projection worksheets comprise a plurality of linked spreadsheet templates. The accompanying notes to pro formas, private placement memoranda, coversheets and tables of contents comprise word processing document templates. For example, the linked spreadsheet templates may be created using Microsoft Excel™ or any other suitable spreadsheet software. Similarly, the word processing document templates may be created using Microsoft Word™ or any other suitable word processing software. The linked spreadsheet templates include a Pro Form a Income Statement Company and Equity Valuation Worksheet (FIG. 2); a Pro Form a Statement Of Operations (FIG. 3); a Pro Form a Statement Of Cash Flows (FIG. 4); a Pro Form a Balance Sheet (FIG. 5); a Pro Form a Depreciation Schedule (FIG. 6); a Sources And Uses Statement (FIG. 7); and a Pro Form a Internal Rate Of Return Statement (FIG. 8). The word processing document templates include Notes To Pro Form a Financial Projections (Appendix A) and examples of private placement memoranda for various capitalization deal structures (not shown). The cover page and table of contents for private placement memoranda for various deal structures that will be described below are found in appendices B-F. Appendix B includes the cover sheet and table of contents for a private placement memorandum for a first round financing for generating seed capital for XYZ Company, Inc. The deal structure incorporates a combination of debt and equity capital, also known as debt with an equity kicker. Appendix C includes the cover sheet and table of contents for a private placement memorandum for a second round of financing for development capital. This deal structure is comprised entirely of debt capital employing royalty financing contracts. Appendix D includes the cover sheet and table of contents for a third round financing for capital expansion. This deal structure includes the issuance and sale of participating preferred stock. Finally, Appendix E includes the cover sheet and table of contents for a private placement memorandum for raising fourth round, second stage expansion capital. This deal structure is comprised entirely of equity in the form of class A common stock.

The entire text of a private placement memorandum template is found in Appendix F. The particular template included in the appendix relates to the debt with an equity kicker deal structure corresponding to the cover sheet and table of contents found in Appendix B. Due to the length of the private placement memorandum, only a single example has been included herewith. However, those skilled in the art will be familiar with the preparation of private placement memoranda and can readily adapt the attached private placement memorandum to the other described deal structures, including hybrid securities offerings, using the additional templates specifically designed to produce the securities offerings documentation.

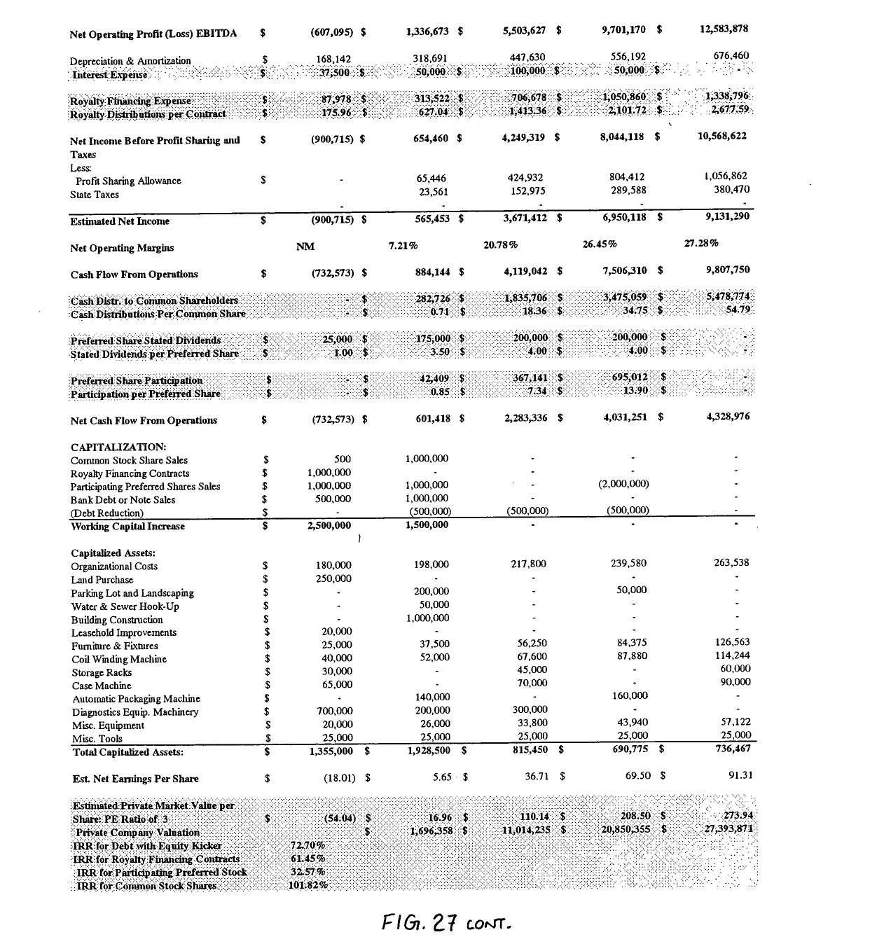

Returning to the pro form a financial projections of FIGS. 2-8, each pro form a financial projection template comprises a spreadsheet document. As with any spreadsheet, the Pro Form a Financial Projection templates comprise arrays of intersecting rows and columns. Row headings and column headings can define the contents of data cells formed at the intersections of the various rows and columns. All of the entries in column A, for example, relate to row headings, and all of the entries in row 2 relate to column headings. The Pro Form a Income Statement and Company Valuation template (hereafter simply “the income statement”) includes six columns A-F and rows 1-126; however, finalized versions of the pro form a financial projections may be produced excluding the alpha-numeric row and column headings as illustrated in FIG. 27. For illustration purposes, each cell in the various pro form a financial projections templates is uniquely identified by the template name and its column letter and row number. Thus, income statement C22 identifies a specific cell at column C, row 22 of the income statement, namely the cell which stores the total cost of goods sold by the enterprise in the second year of its capitalization plan. Data in other cells and in other templates can be identified in the same manner.

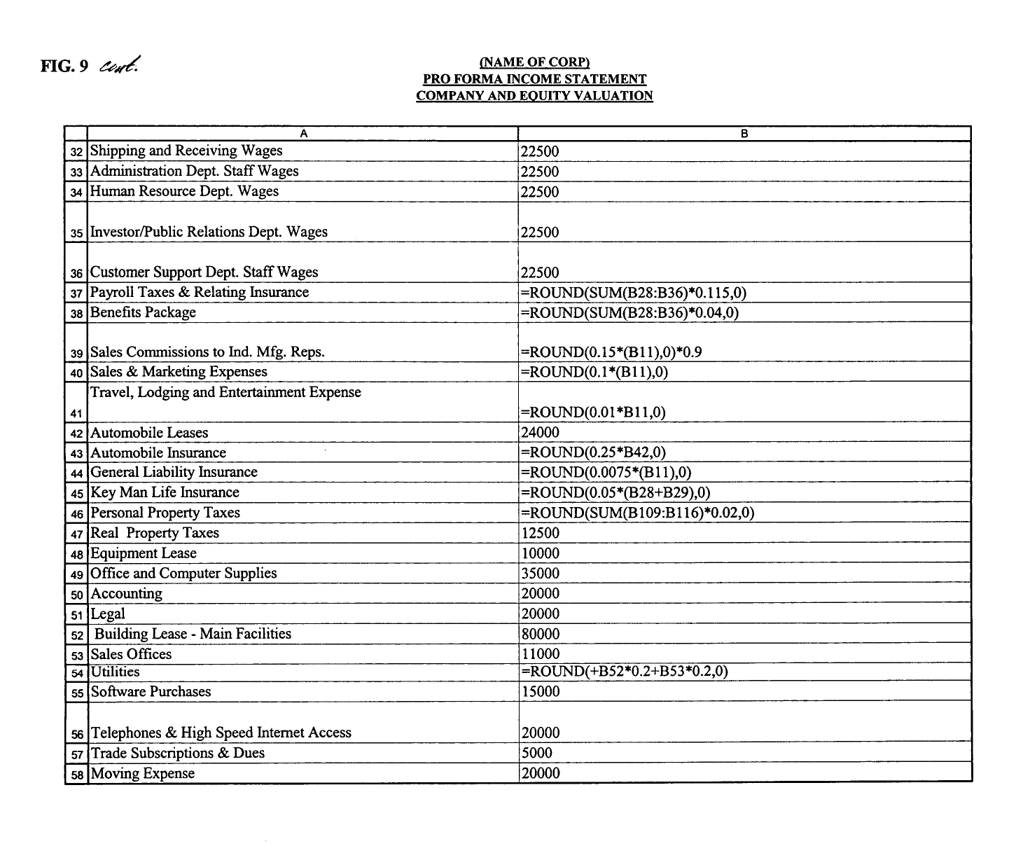

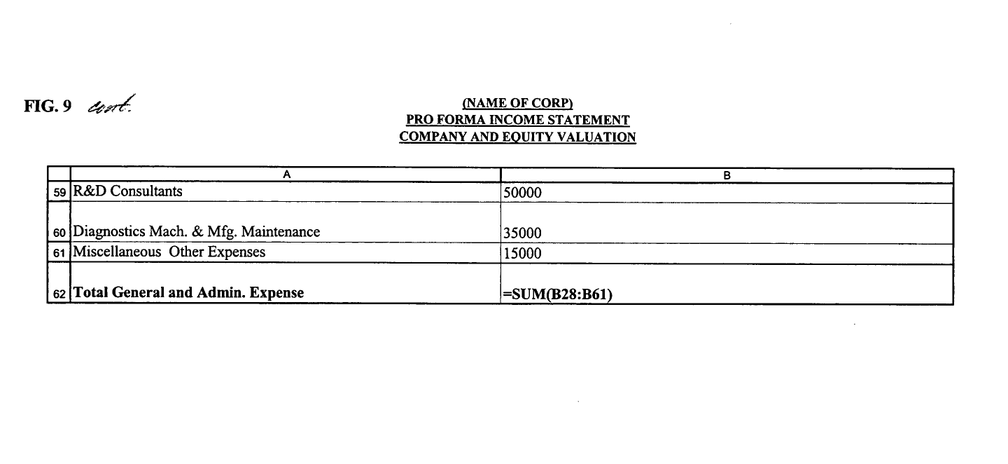

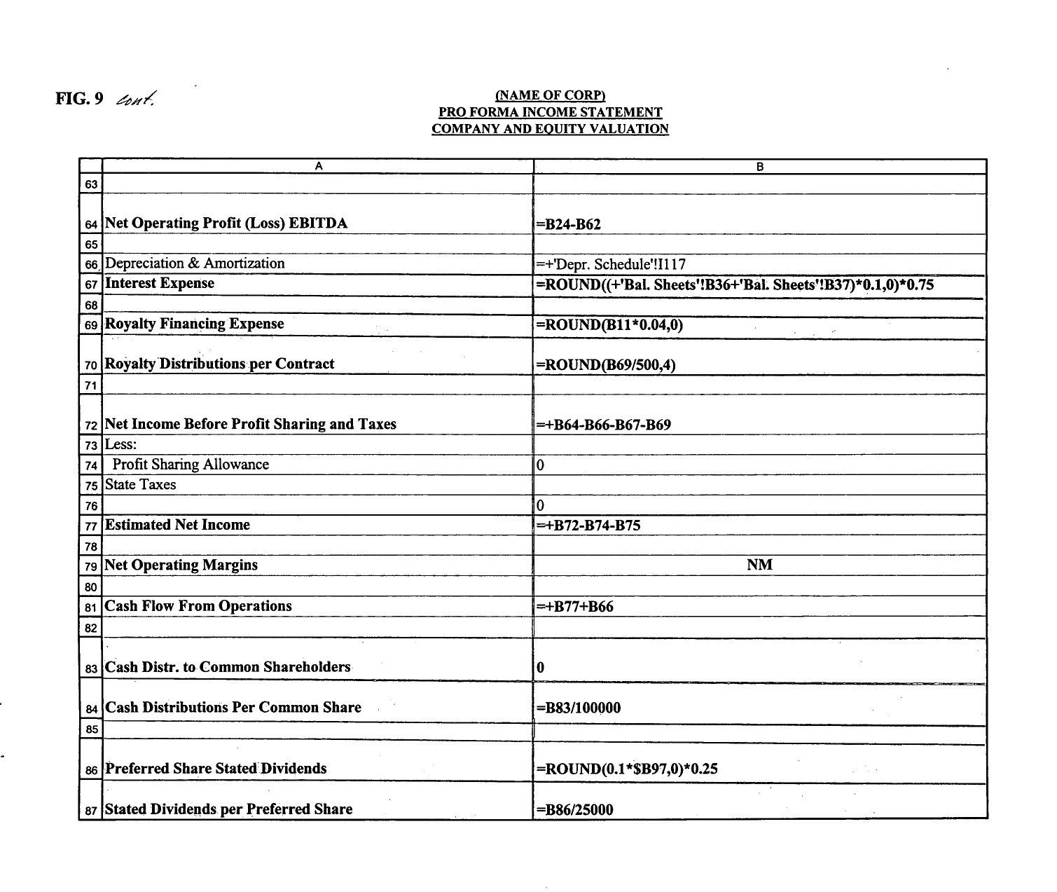

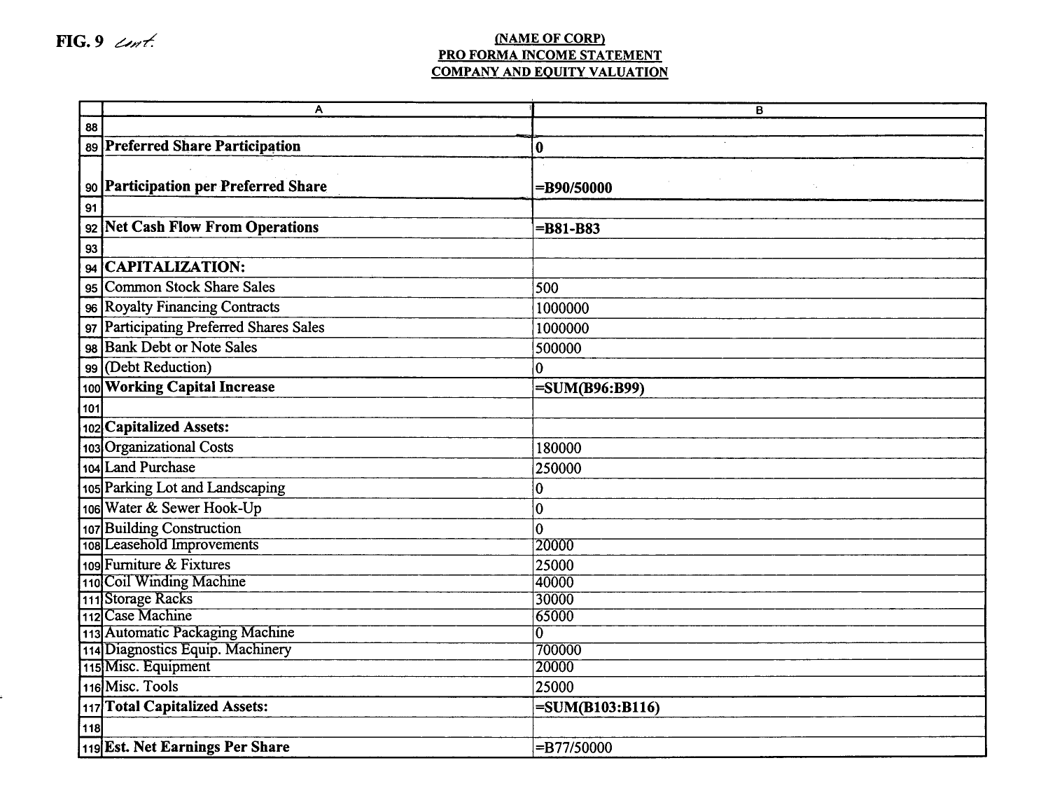

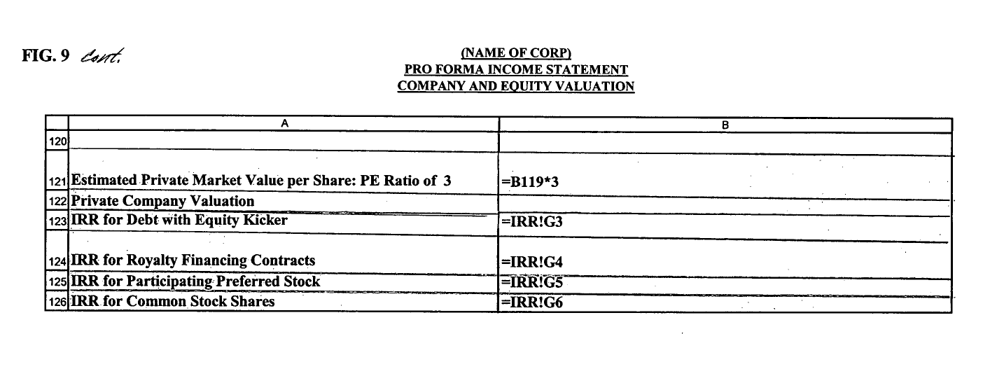

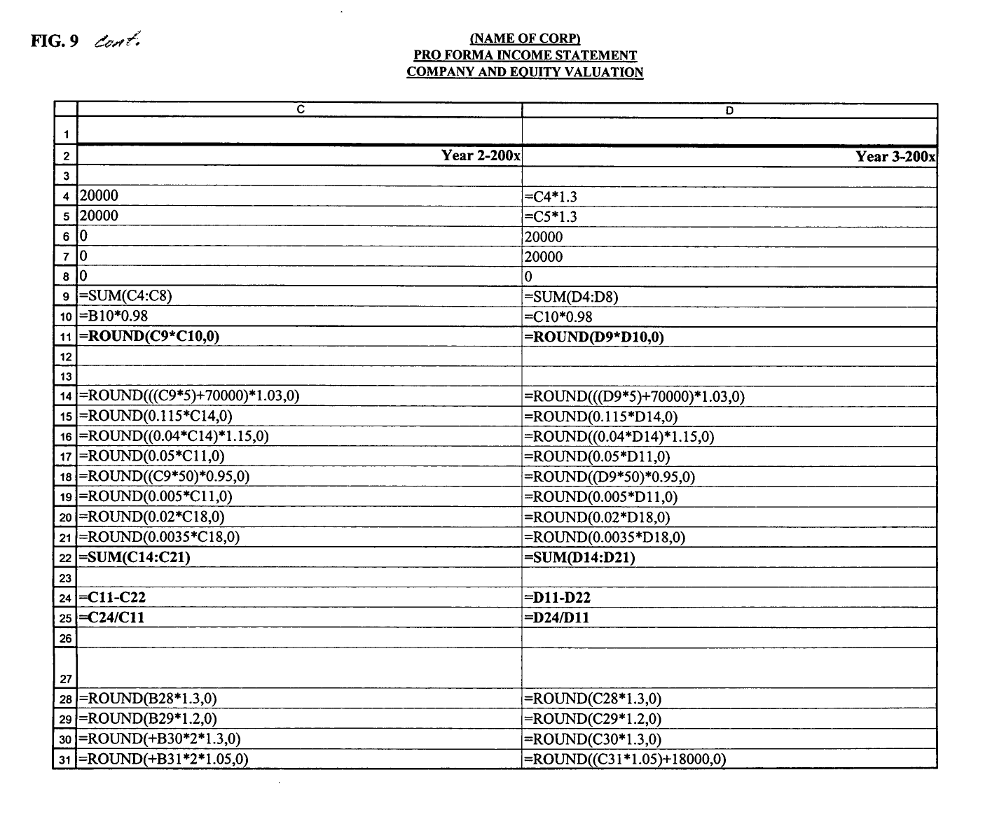

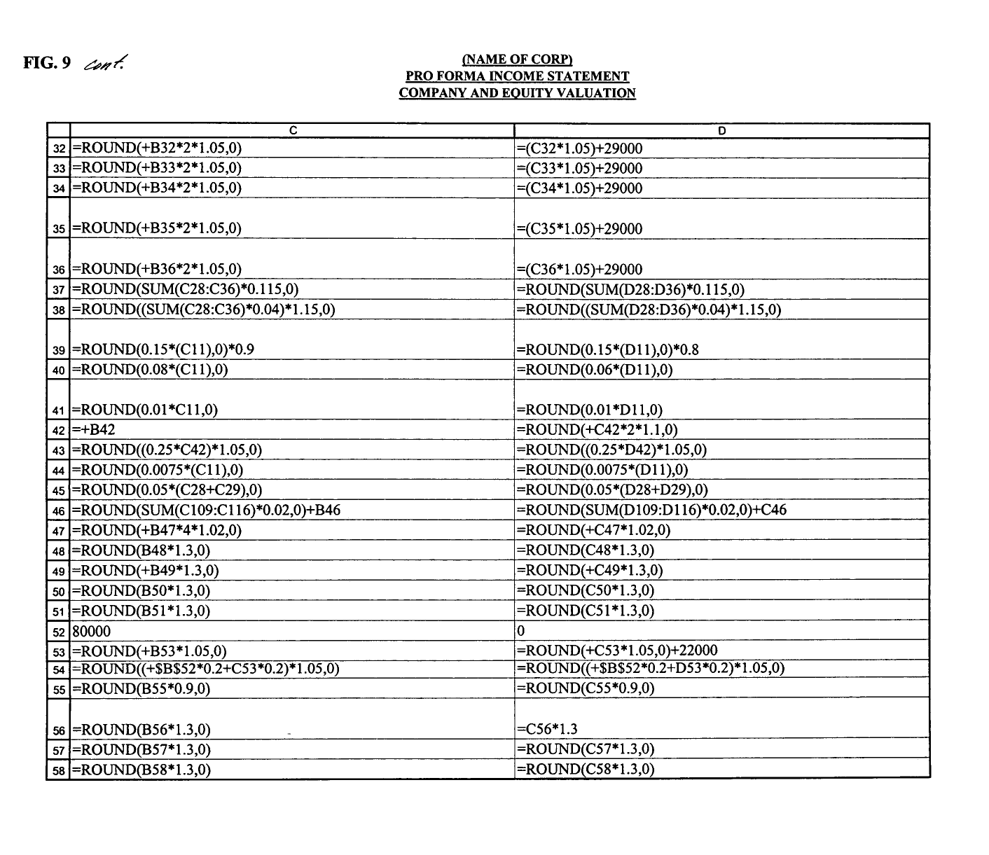

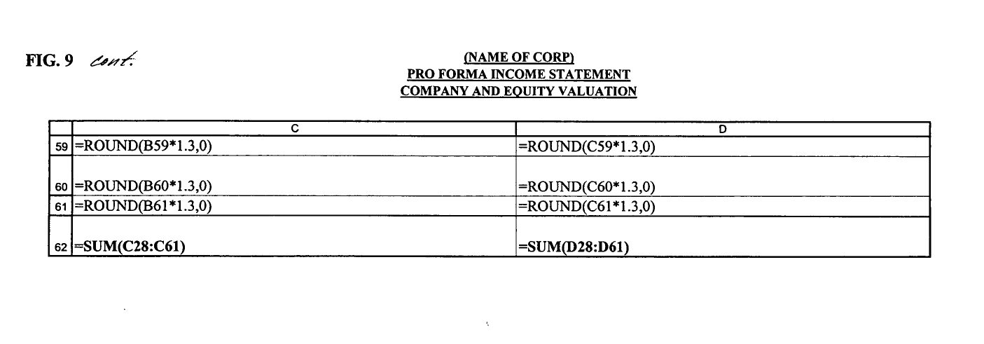

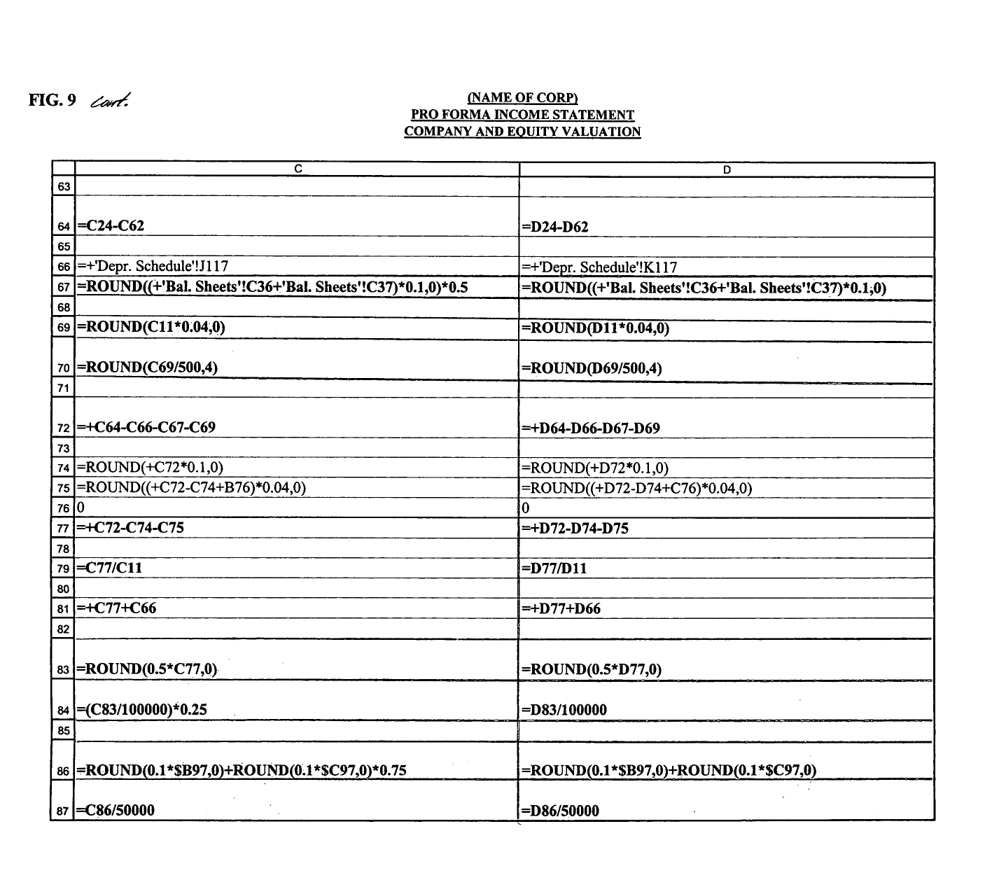

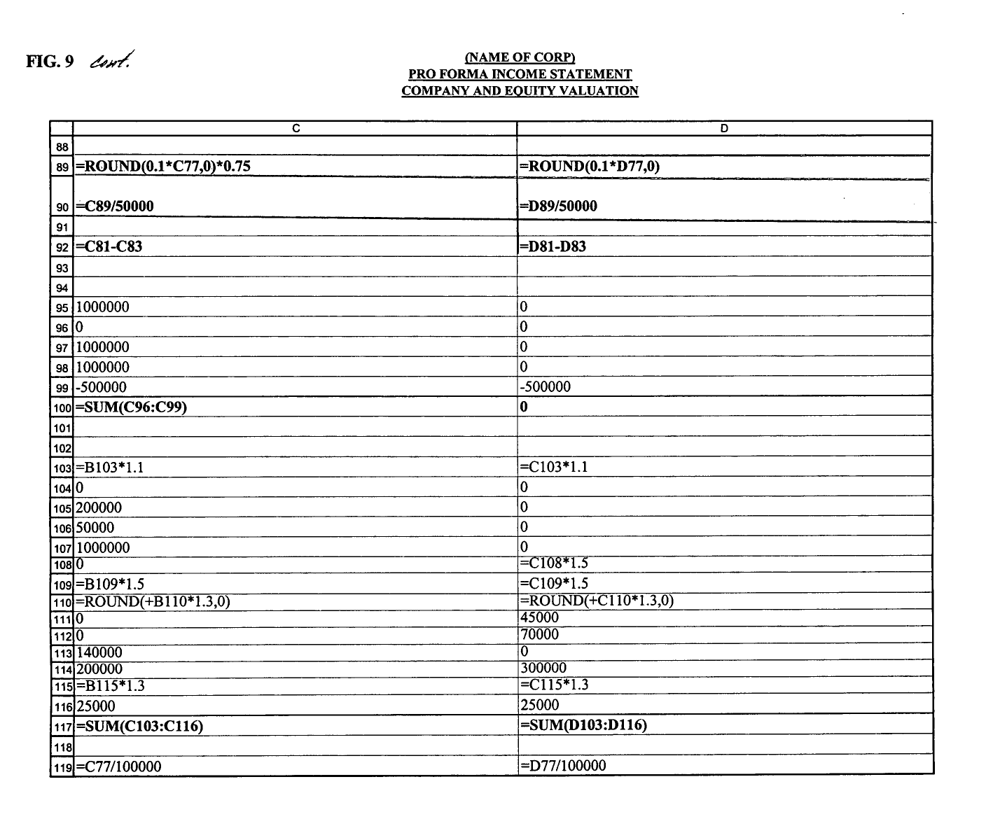

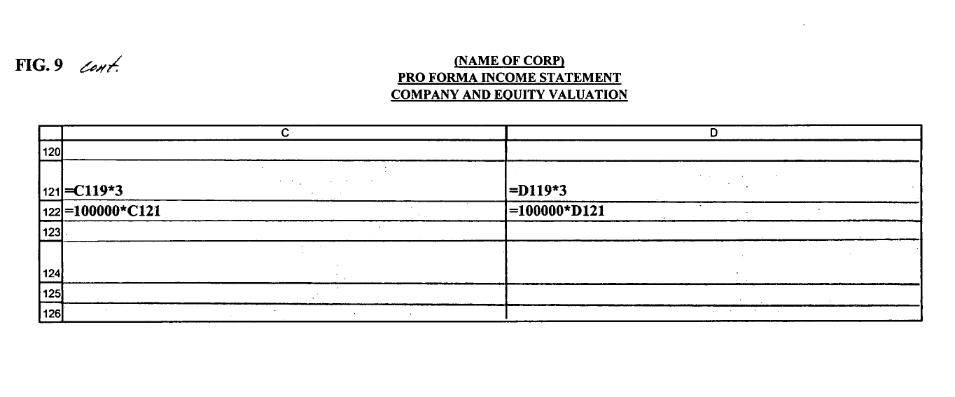

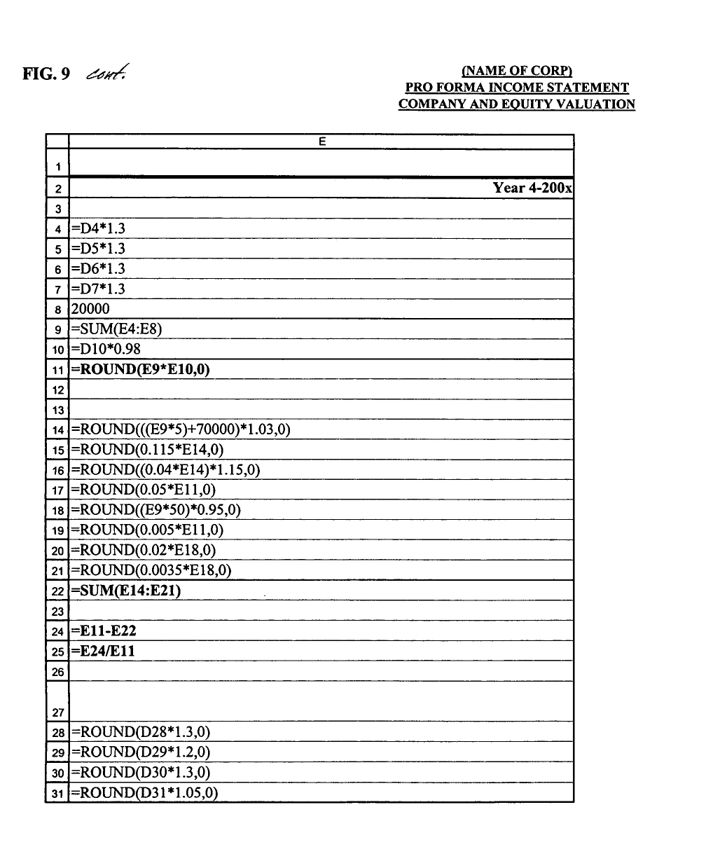

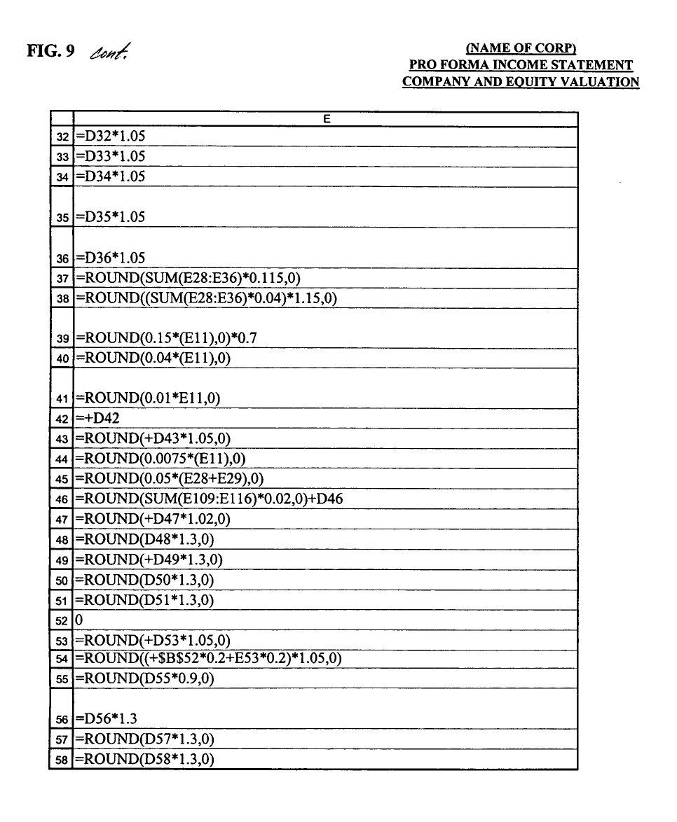

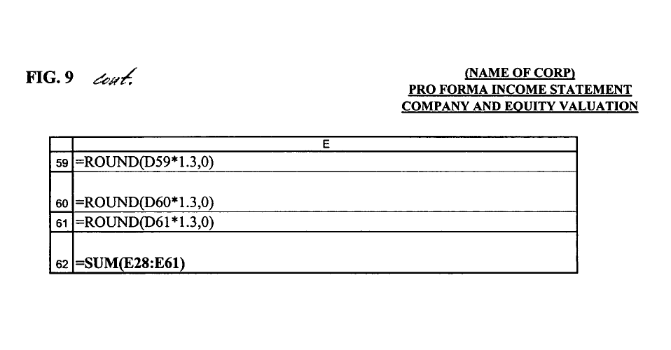

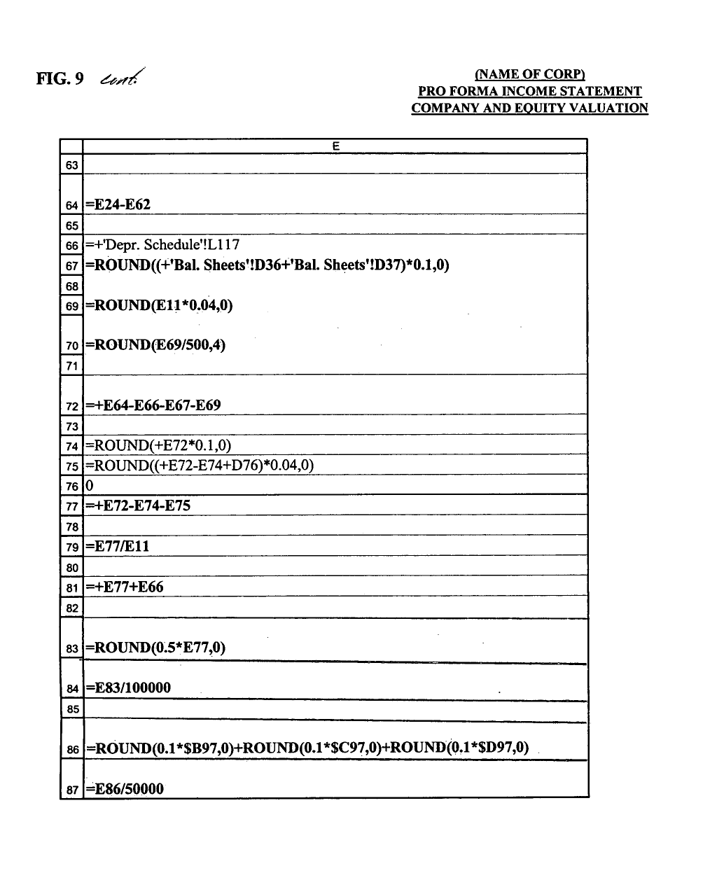

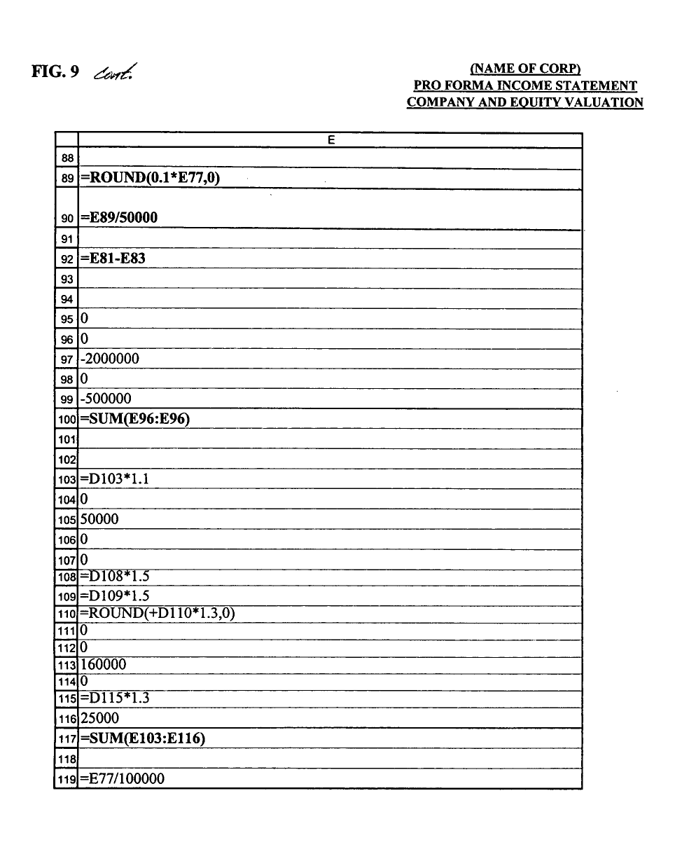

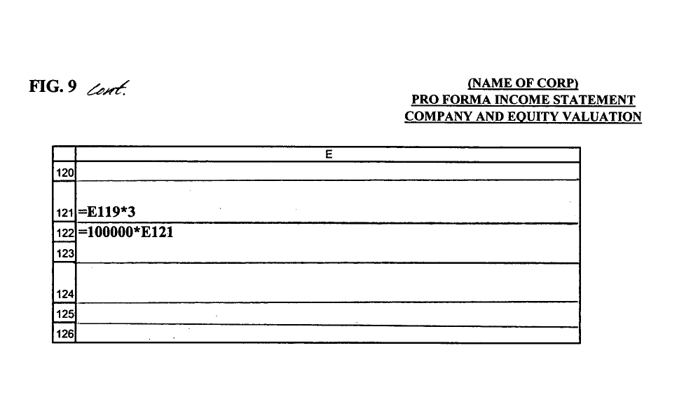

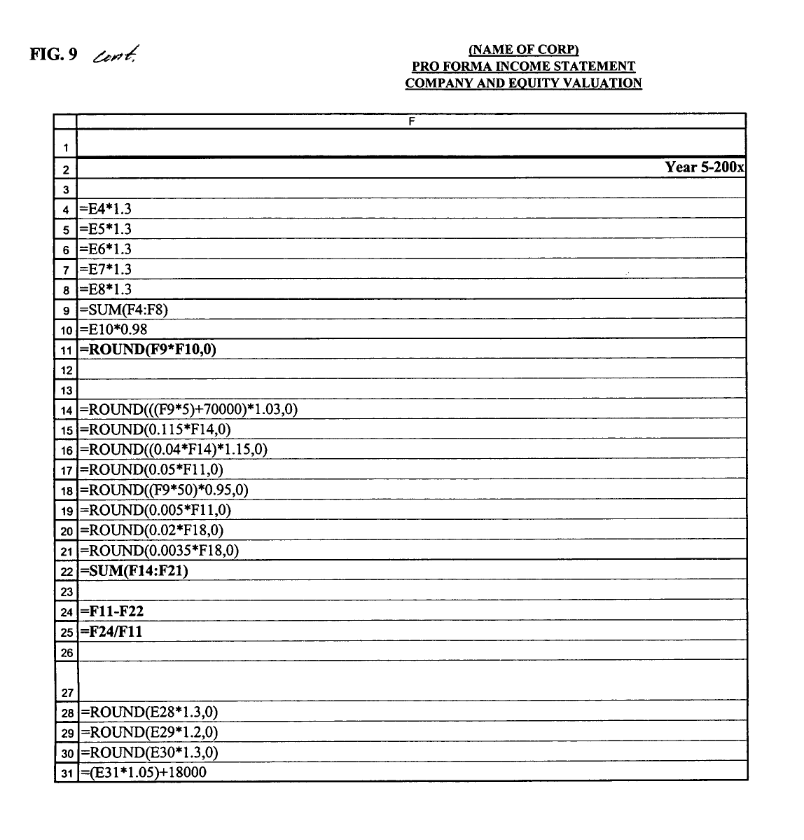

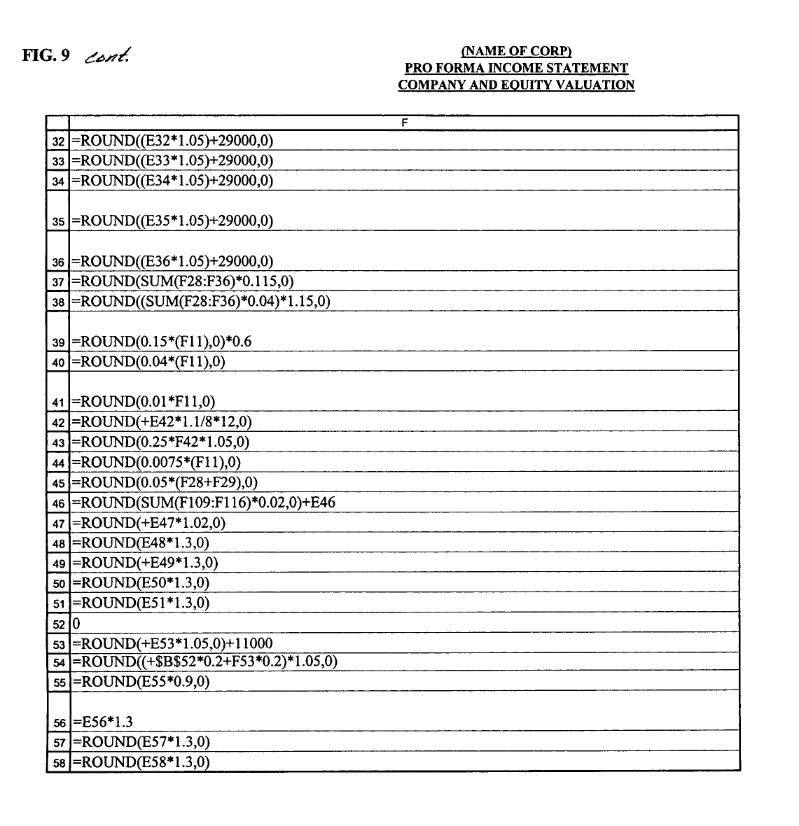

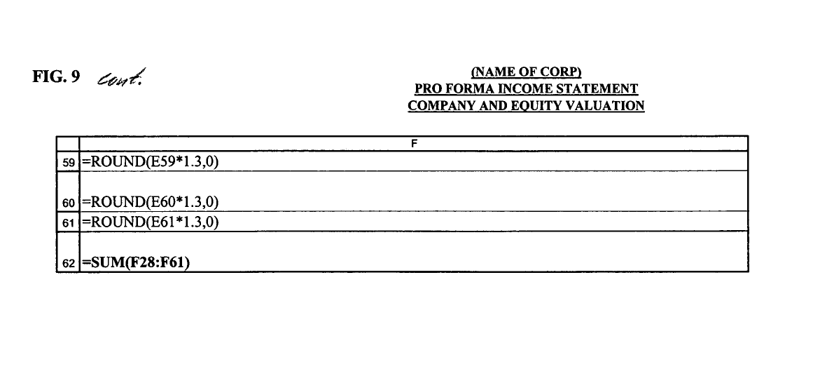

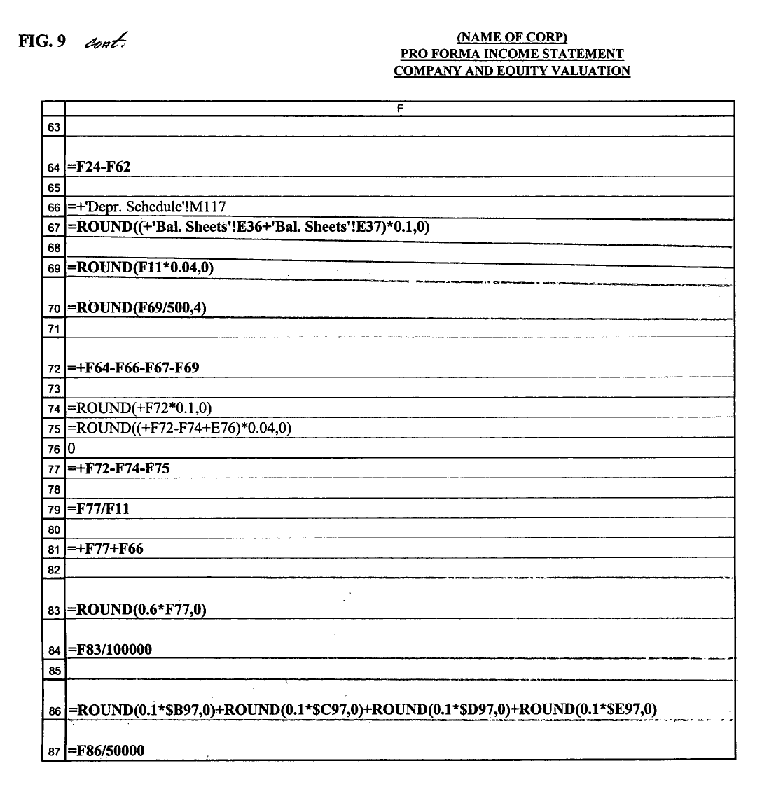

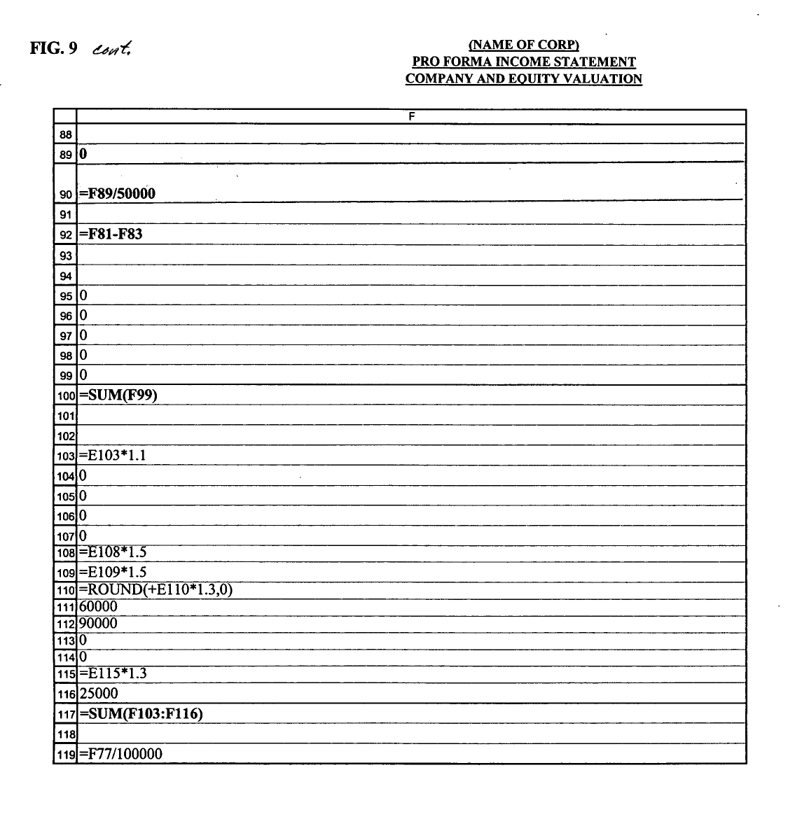

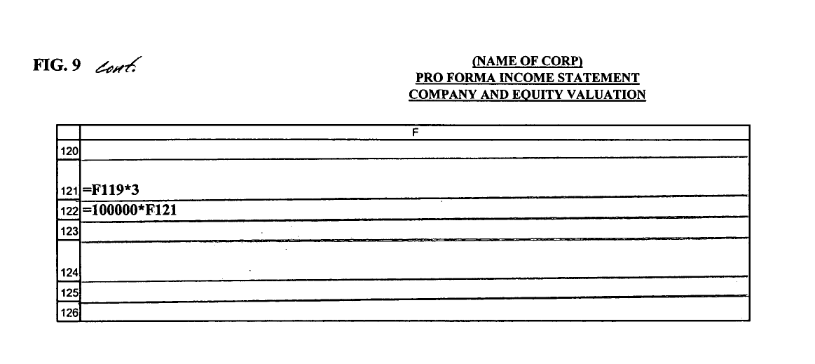

The individual cells within the various templates are configured according to the content they hold. For example, column A of the income statement template is limited to row headings. Cells in column A, therefore, are configured to receive text as required by the user. Other cells are configured to receive numerical values entered by the user. For example, cells B4, C4, D4, E4, and F4 of the income statement are adapted to receive data representing U.S. domestic unit sales for each of the first five years of its capitalization plan. Other cells are configured to perform calculations based on data entered elsewhere in the template or taken from other templates. For example, cell C11 of the income statement template represents the total gross sales in the second year of the capitalization plan. The value in this cell is determined by multiplying the value in cell C9 (total unit sales) by the value in cell C10 (average sale price per unit) and rounding the result to the nearest dollar. Compare this to income statement cell D67. The value for this cell is determined by adding content from a different worksheet, namely, the pro form a balance sheet. The values of cells C36 and C37 of the pro form a balance sheet illustrated in FIG. 5 are added together and multiplied by 0.1. This is illustrated by the formula found in the corresponding cell D67 of FIG. 9. The result is rounded to the nearest dollar. Referring to the Balance Sheet template illustrated in FIG. 5, cell C36 stores the value $1,500,000 and cell C37 contains the value, −$500,000. Thus, the value stored in income statement D67 is $100,000 ($1,500,000+−$500,000×0.1).

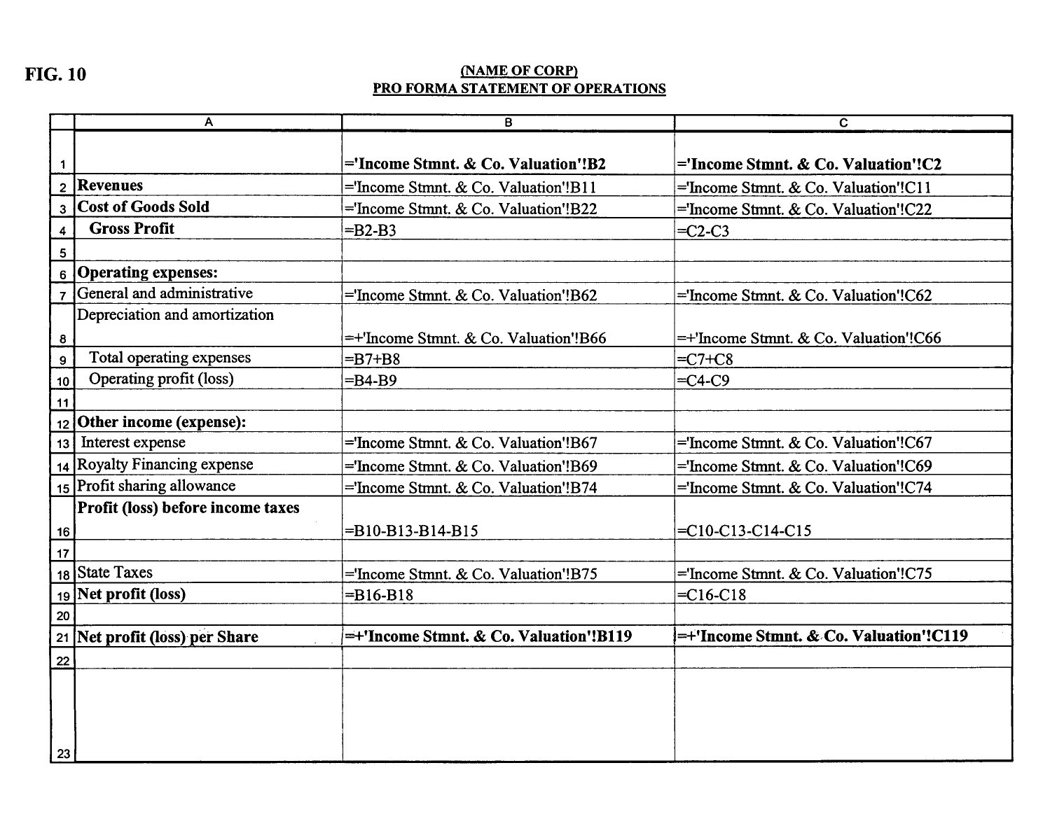

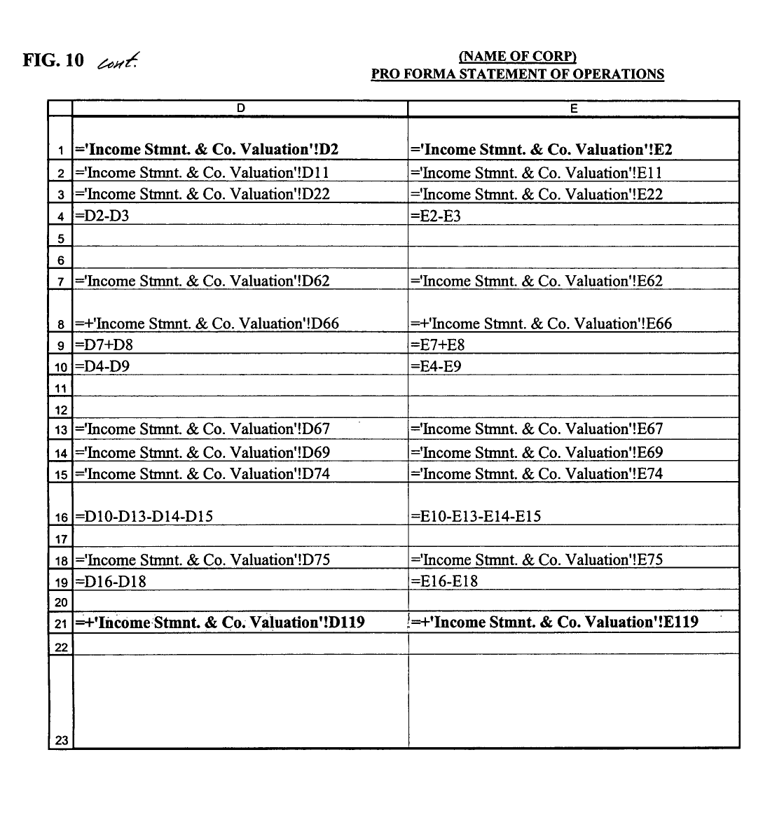

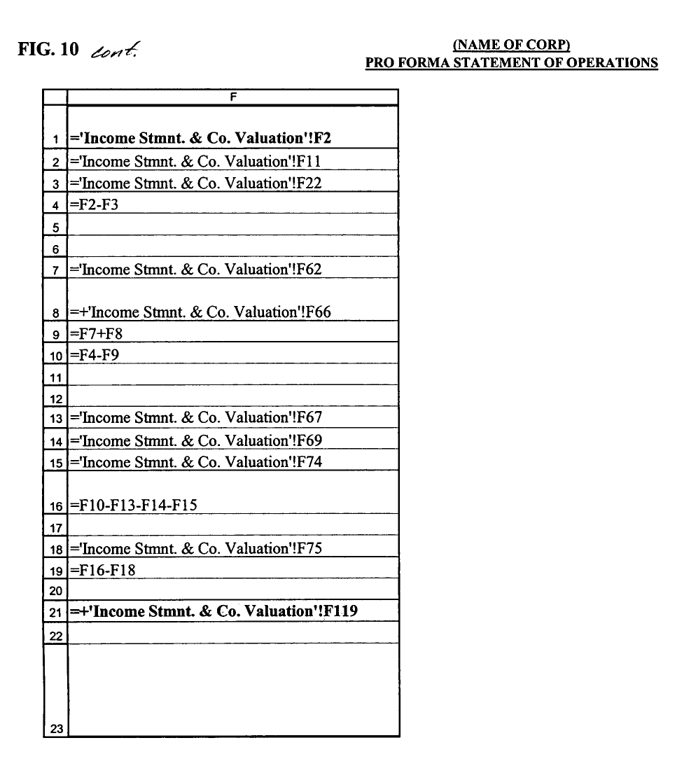

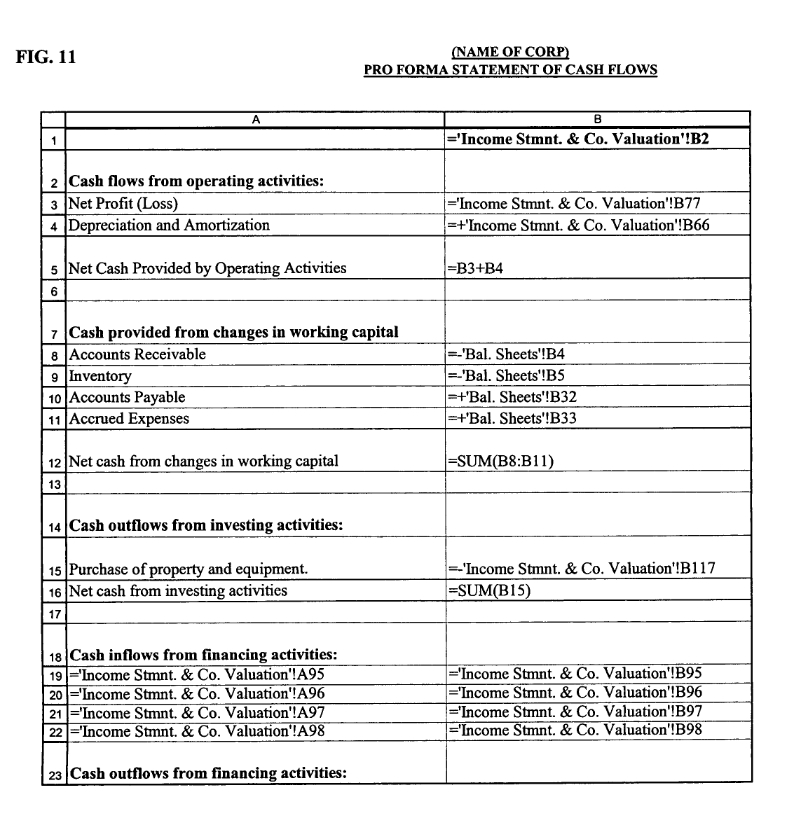

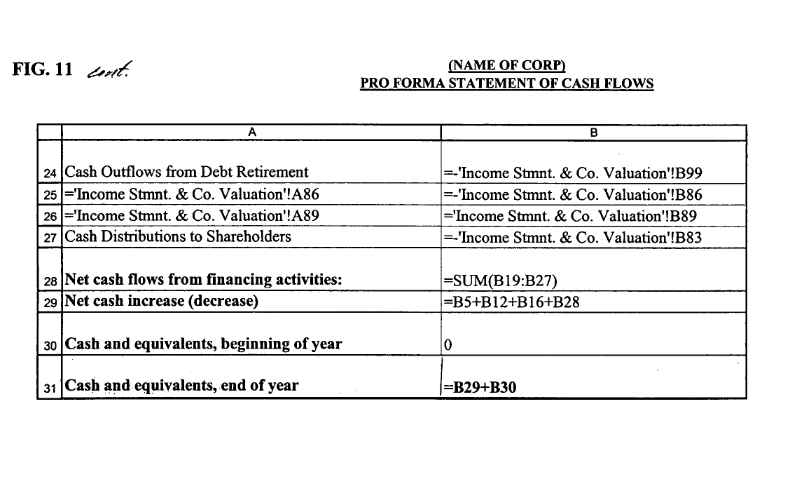

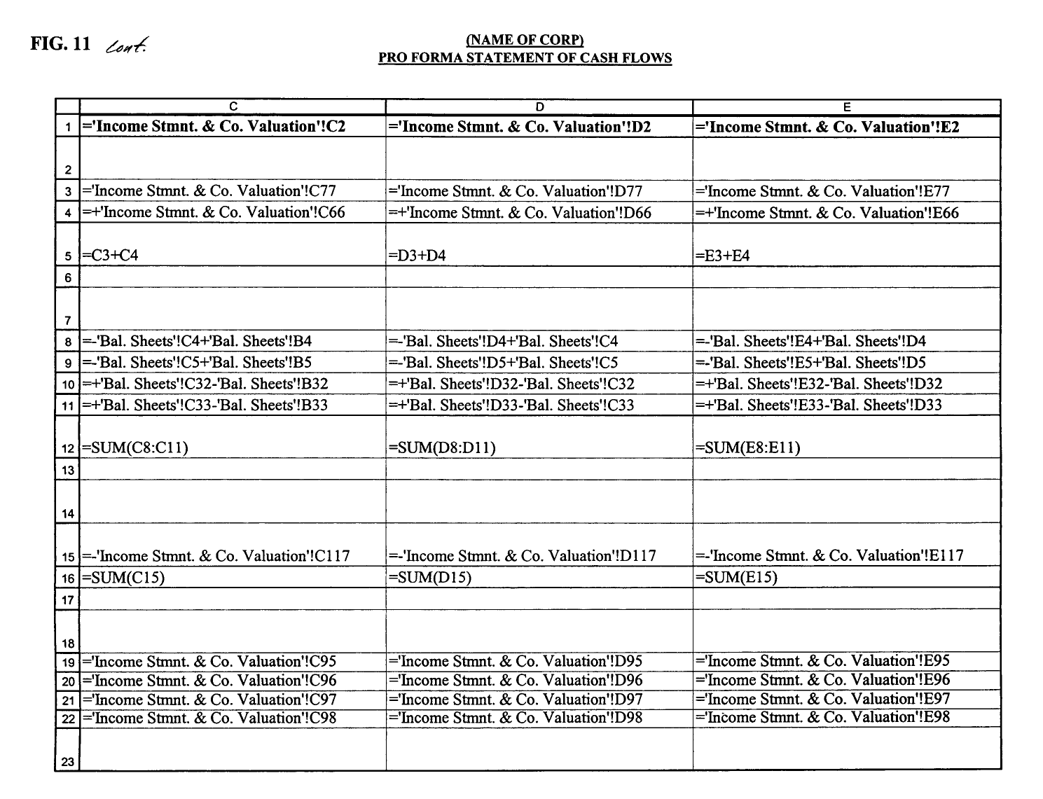

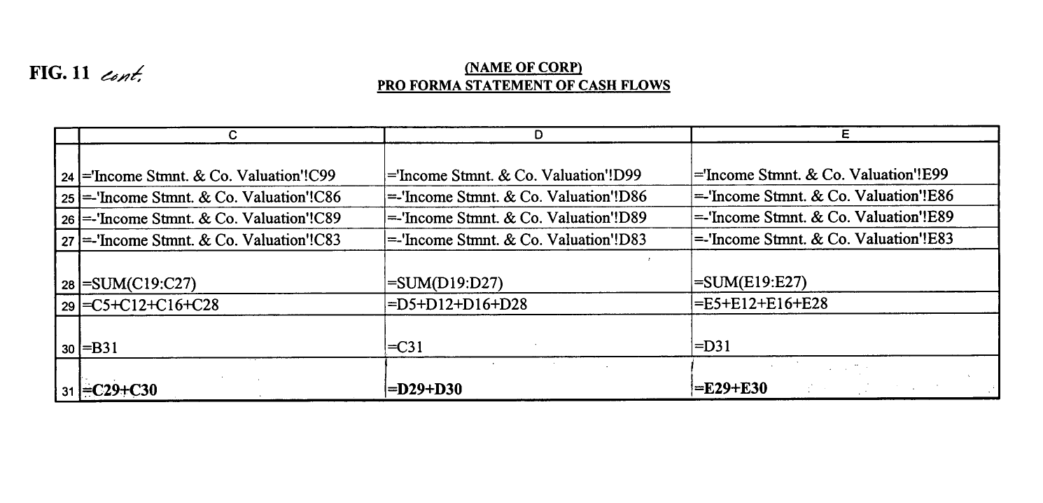

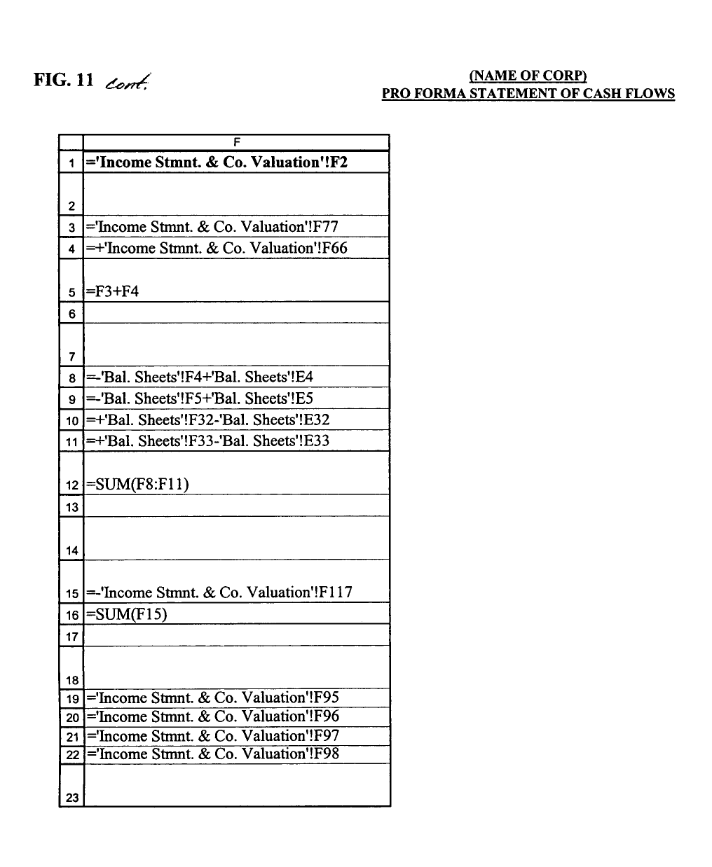

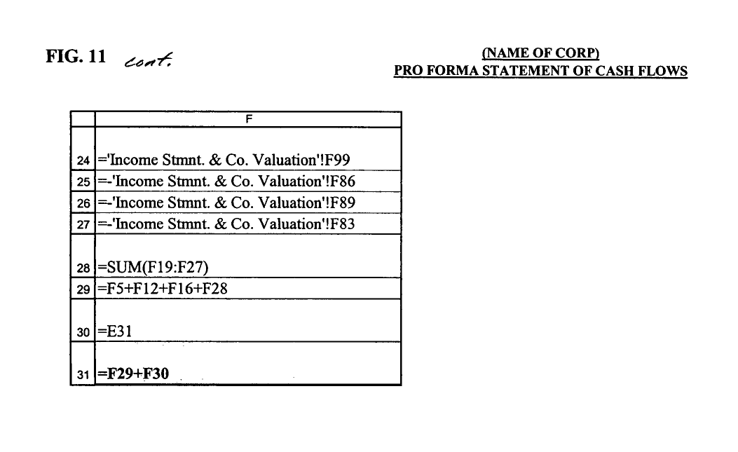

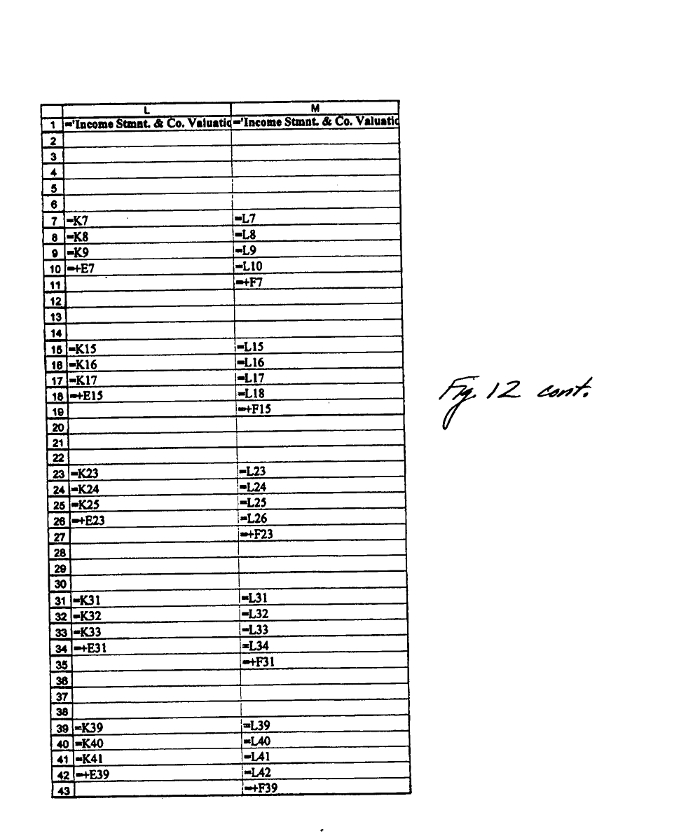

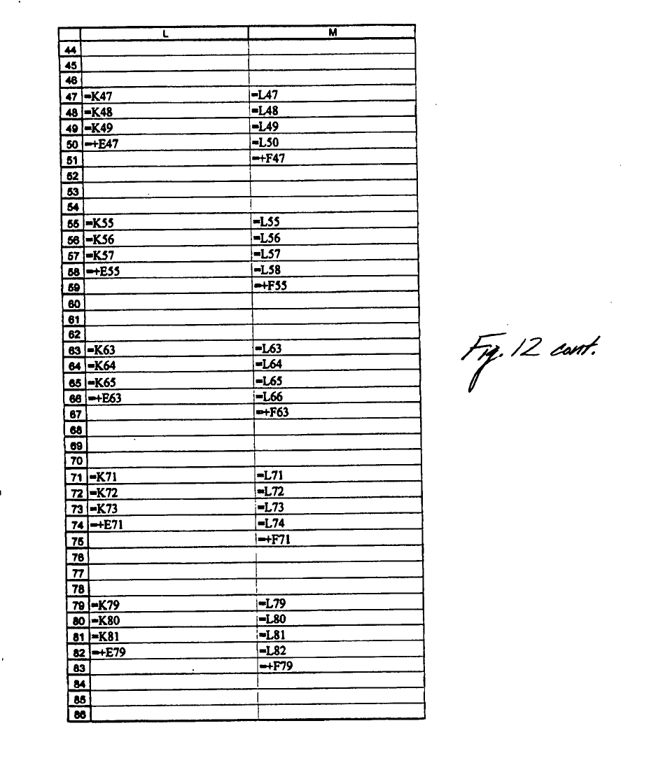

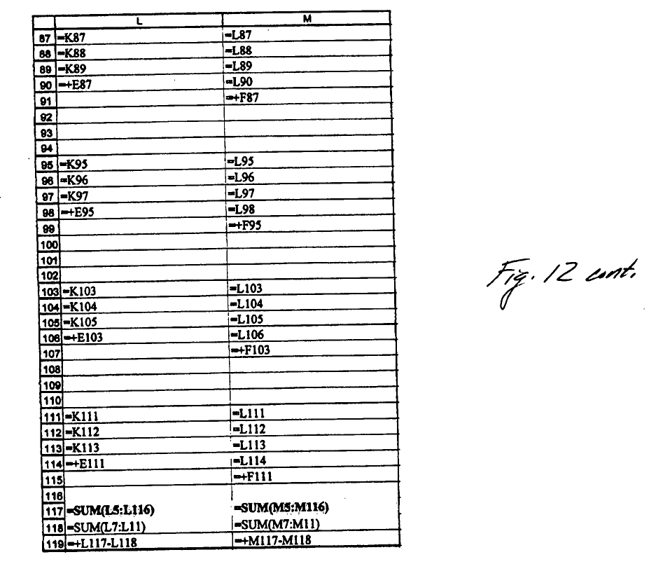

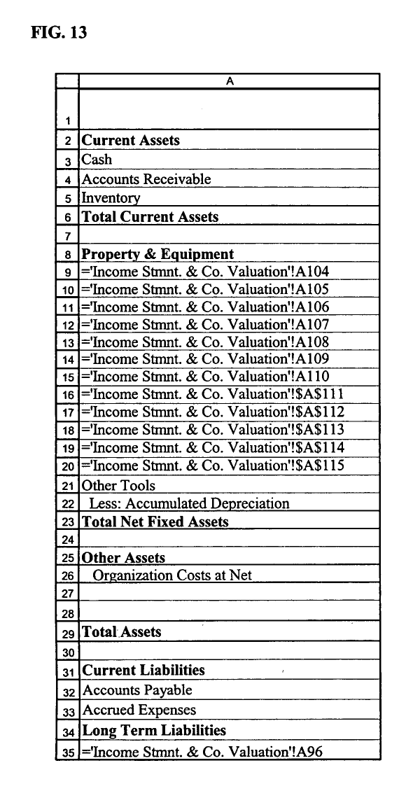

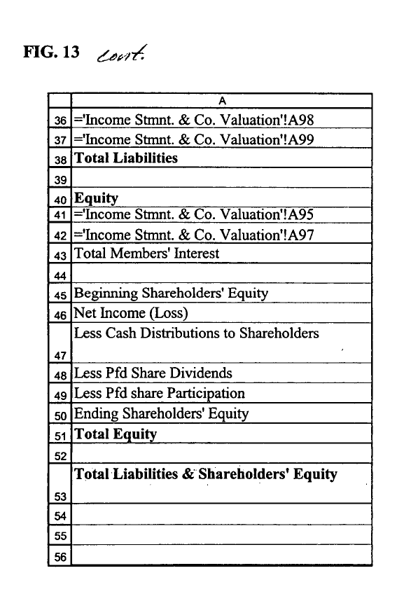

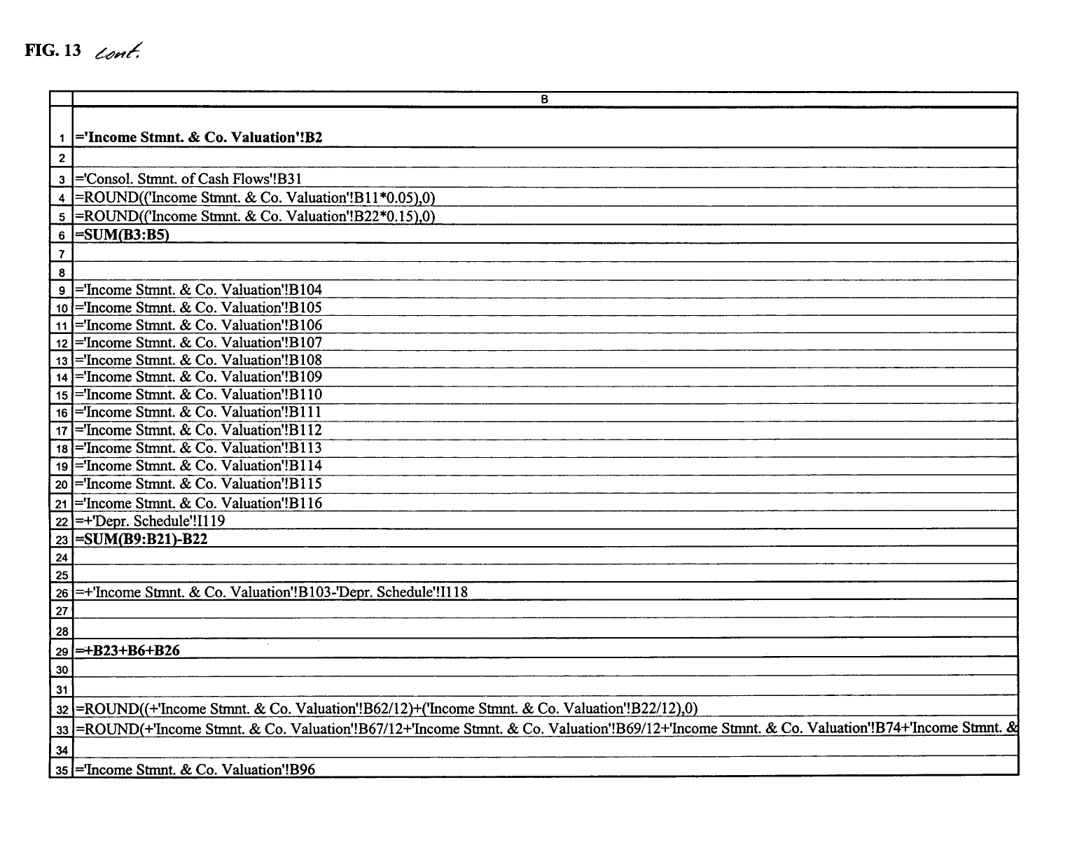

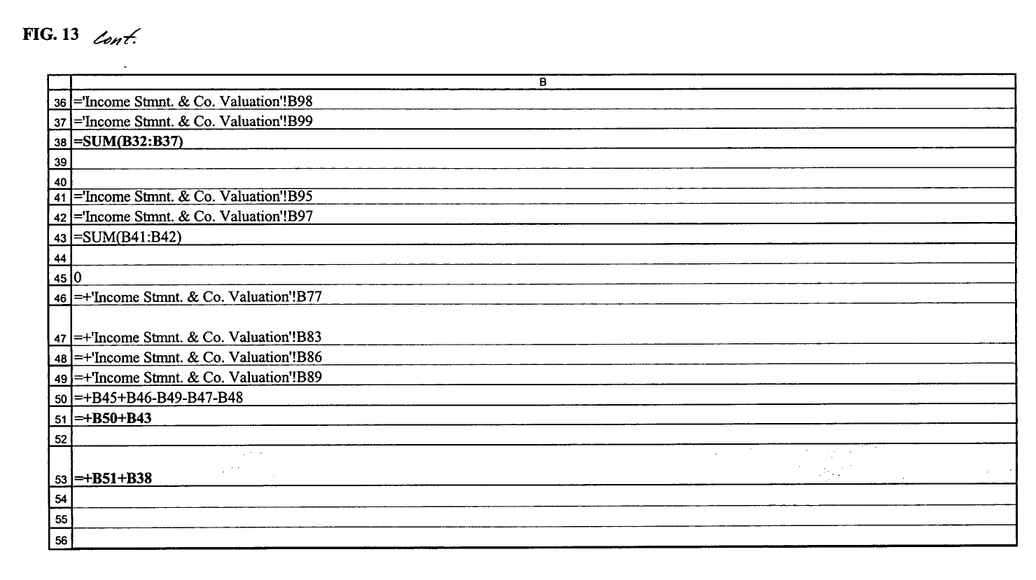

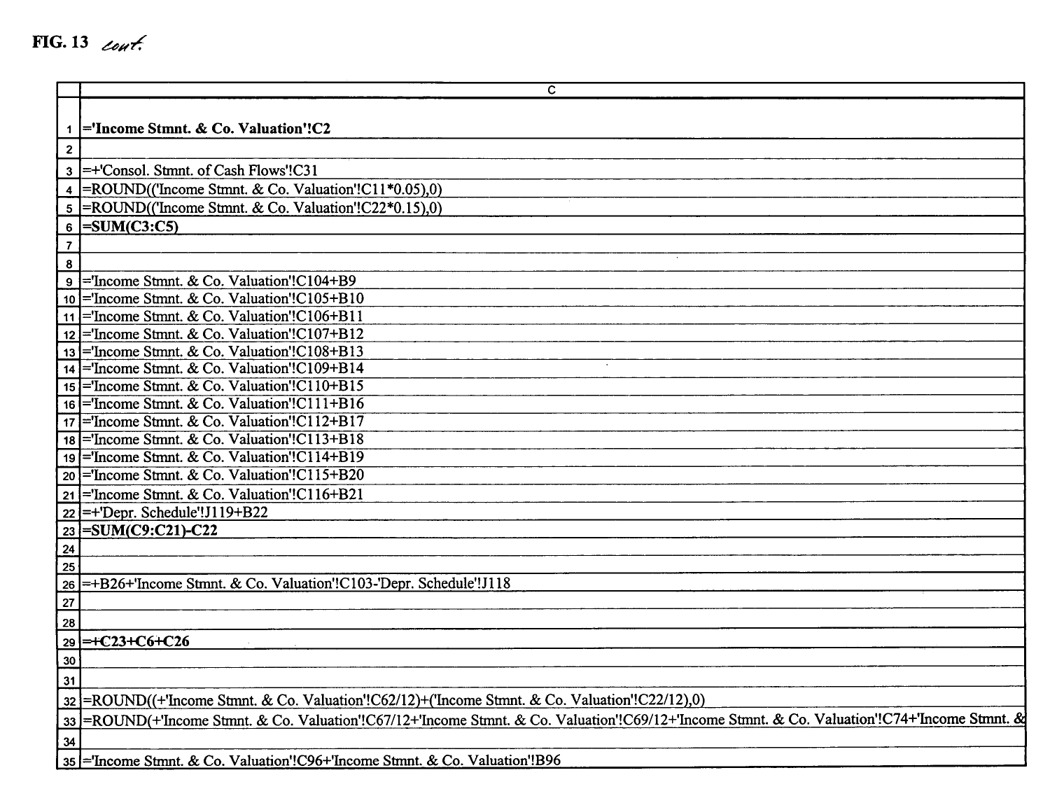

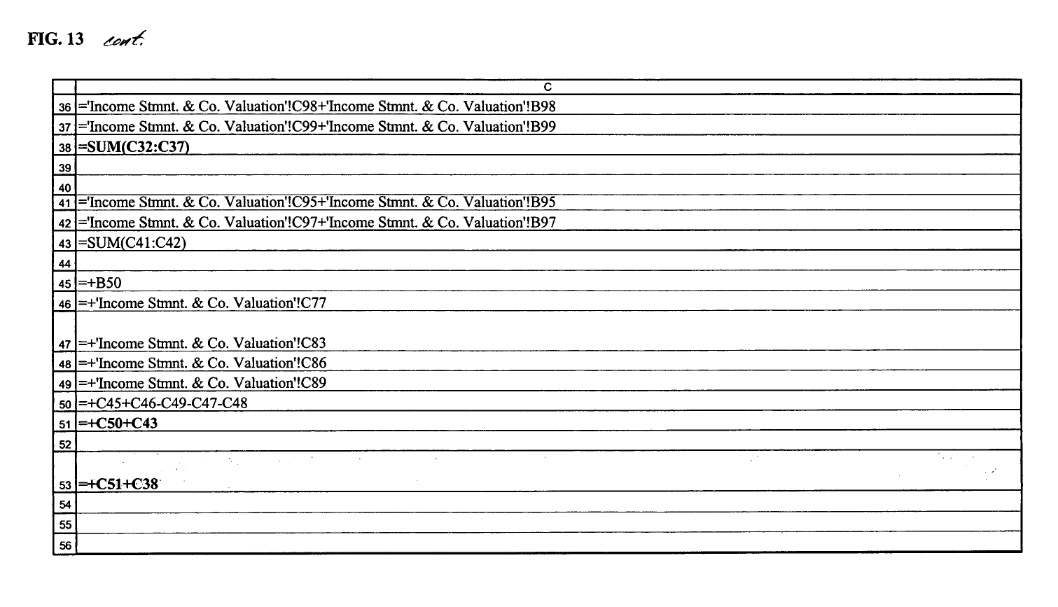

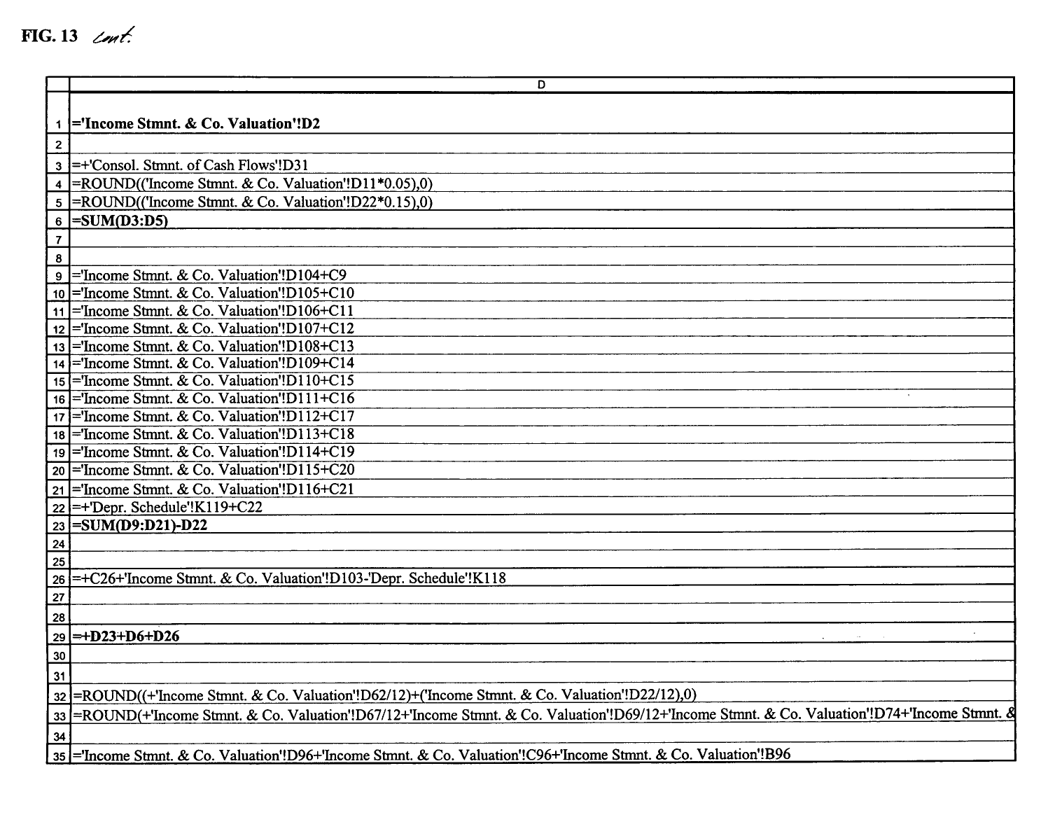

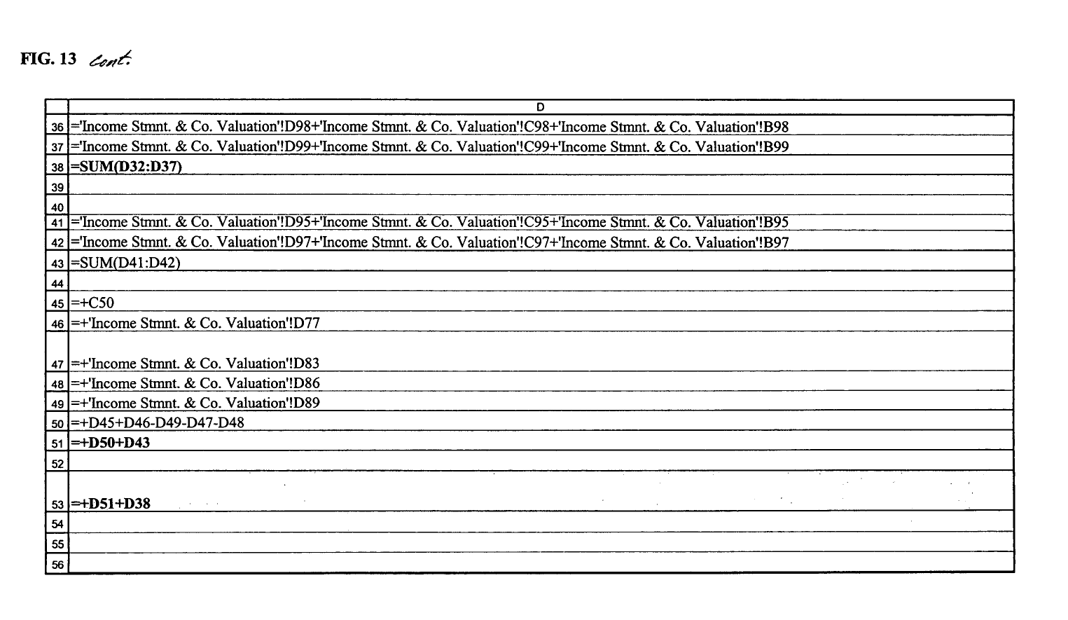

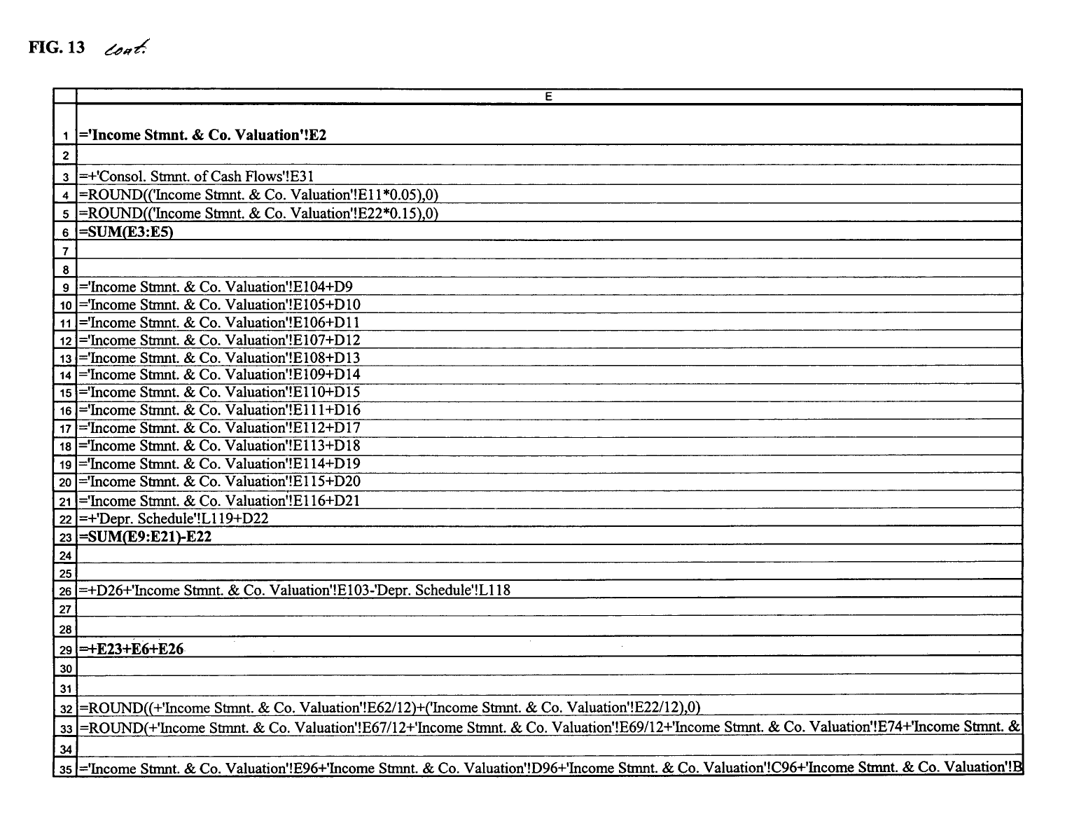

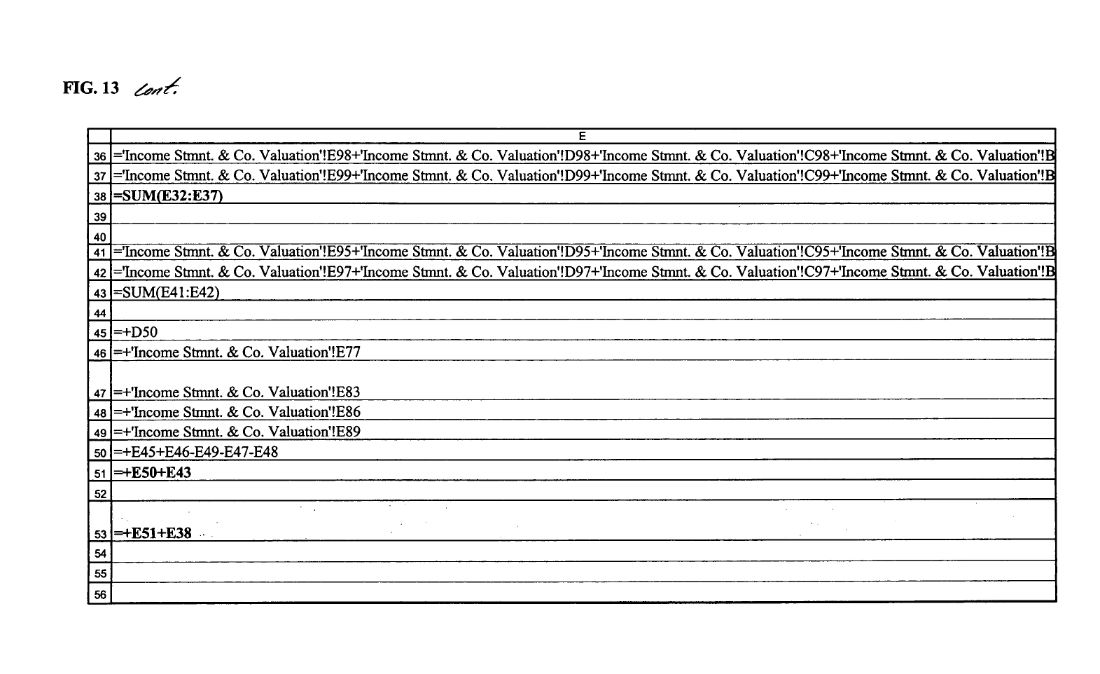

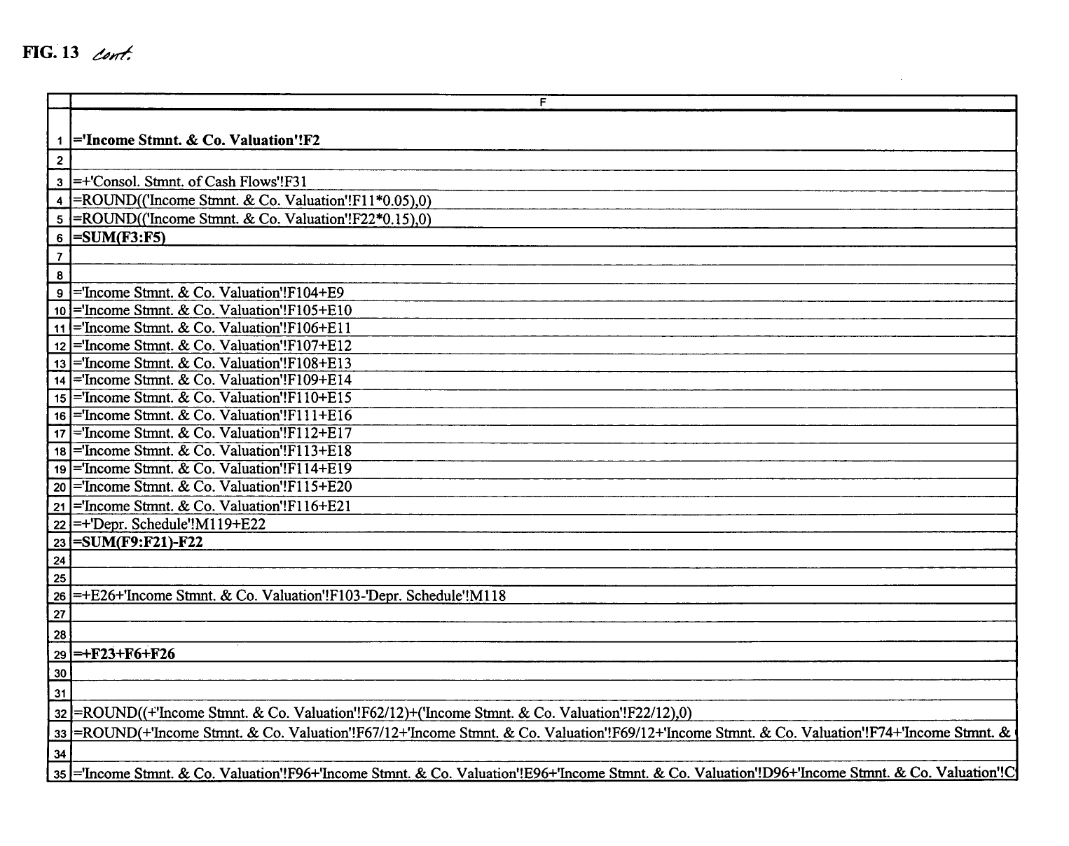

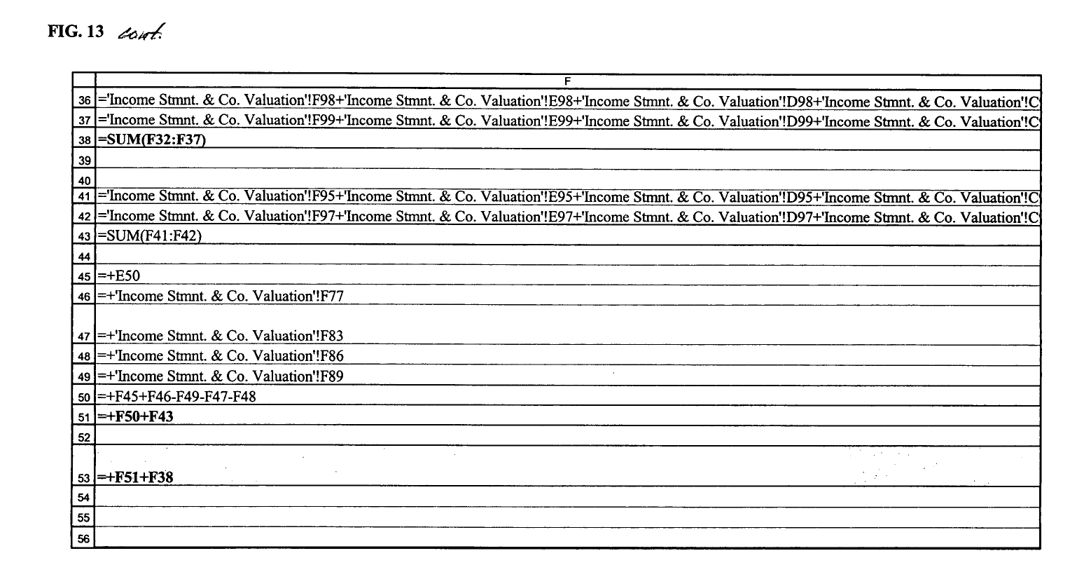

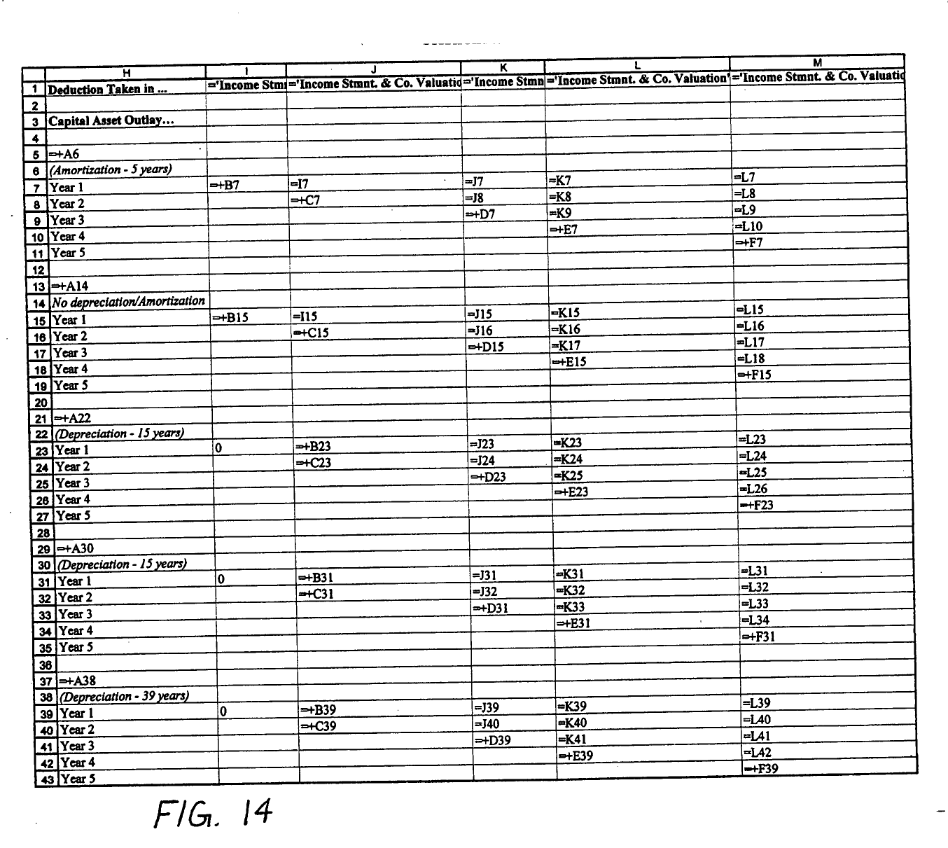

Formulas such as those just described, wherein the content of a cell in a first template depends on data entered or calculated in another cell and/or template, create linkages between the pro form a financial projections templates. Data flow seamlessly between the templates so that when a user changes the data or formulas in one cell and/or template, the changes are propagated throughout the linked cells and/or templates. The pro form a financial projections are illustrated again in FIGS. 9-15. However, this second set of pro form a financial projections display the formulas used to calculate the data in various cells. As will be readily apparent, linked templates allow the user to easily change various aspects of the pro form a financial projections to change their capitalization plans in order to test various funding scenarios and to determine which investment deal structures are most appropriate for the enterprise and which are most likely to attract investors.

In order to demonstrate the power of the present invention, a sample capitalization plan is developed using the templates described above. As illustrated in the templates in FIGS. 2-8, templates are “preloaded” with hypothetical data representing performance projections for a hypothetical enterprise, XYZ Company. First time users of the invention are encouraged to walk through an example of generating a fully integrated capitalization plan for the XYZ Company using the “pre-loaded” values in the templates. Once the user is comfortable with using the templates, he or she may copy them under a new file name and change them as necessary to generate a capitalization plan for his or her own enterprise. For purposes of describing the present invention, the present discussion is limited to following the example of developing a capitalization plan for the hypothetical XYZ Company. It is assumed that the user is the entrepreneur who started XYZ Company or is otherwise associated with XYZ Company.

In order to generate a capitalization plan, the user must first determine the capital requirements of the enterprise. Beginning with the pro form a income statement and company valuation template, FIG. 2, the template is divided into several sections. The first section 12 relates to revenue assumptions for the enterprise's first five years of operation. Entries in the various rows in this section include unit sales in various international markets (rows 4-8), total unit sales (row 9), and the average sale price per unit (row 10). These data result in total gross sales (row 11). Based on the data contained in the template, the enterprise is expecting to have $2,199,450 in total gross sales in its first year (B11), $7,838,040 in its second year (C11), $17,606,942 in its third year (D11), $26,271,511 in its fourth year (E11), and $33,469,905 in its fifth year (F11).

The next section 14 relates to the cost of goods sold. Again, various expenses are itemized for each of the first five years in rows 14-21. The projections for the total cost of goods sold are calculated in row 22. The totals displayed in row 22 are the sums of the various expenses in rows 14-21 in each of the first five years. The expected total cost of goods sold in the first year is $891,7956 (B22), $2,698,617 in the second year (C22), $6,078,167 in the third year (D22), $9,150,161 in the fourth year (E22), and $11,832,526 in the fifth year (F22).

The total gross profit is calculated in row 24 from the total gross sales (row 11) and the total cost of goods sold (row 22). The gross margin percent is calculated in row 25 from the gross profit (row 24) and total gross sales (row 11).

The next section 16 of the income statement relates to general and administrative expenses. Various general and administrative expenses are listed for each year in rows 28-61. Total general administrative expenses are calculated in row 62. Here, XYZ Company expects to incur $1,914,750 in general and administrative expenses in the first year of its capitalization plan (B62), $3,802,750 in the second year (C62), $6,085,148 in the third year (D62), 7,420,180 in the fourth year (E62), and $9,053,501 in the fifth year (F62).

Following the general administrative expenses the next section 18 extends from the net operating profit (loss) EBITDA, row 64, through cash flow from operations, line 18. The net operating profit or loss or earnings before interest, taxes, depreciation and amortization (EBITDA) is calculated in row 64. Depreciation and amortization is calculated in row 66; interest expense in row 67; royalty financing expense in row 69; royalty distributions per contract in row 70; net income before profit sharing in row 72; profit sharing allowance in row 74; state taxes in row 75; estimated net income in row 77; net operating margins in row 79; and cash flow from operations in row 81. The net operating profit (row 64) is calculated for each of the company's first five years by subtracting the general and administrative expenses (row 62) from the gross profits (row 24). The depreciation and amortization values (row 66) are taken from row 117 of the pro form a depreciation schedule (FIG. 6) as discussed below. The depreciation schedule employs the straight line method for amortizing and depreciating asset purchases expected to be made as the enterprise expands.

Row 67 of the income statement relates to interest expenses. Initially, the cells in this row and other rows related to capitalization of the enterprise can be set to zero to value the enterprise prior to developing a capitalization plan. The final plan may or may not include debt financing. However, if a capitalization plan is adopted which includes debt, the data in the interest expense cells are calculated by multiplying the value found on row 36 of the Balance Sheet, “Bank Note or Debt” (FIG. 5) by an estimated interest rate which is 10% in the hypothetical example illustrated in FIG. 9. Similarly, the cells in rows 69 and 70, which represent royalty contract financing and the amount of royalty distributions per contract, are also initially set to a zero basis for purposes of valuing the company. If a capitalization plan is implemented that includes royalty financing contracts, the royalty financing expenses are calculated by multiplying the total gross sales (row 11) by the royalty rate. The royalty financing expense is zeroed out by entering a 0% royalty in the formula for calculating the royalty financing expense instead of 4% as illustrated in row 69 of FIG. 9. This has the effect of also zeroing out the Royalty Distributions Per Contract cells in row 70.

Net income before profit sharing and taxes is calculated in row 72 by subtracting the depreciation and amortization (row 66), interest expense (row 67) and royalty financing expense (row 69) from the net operating profit (row 64). A profit sharing allowance is calculated in row 74 and state taxes are estimated in row 75. Estimated net income is calculated in row 77 by subtracting the profit sharing allowance (row 74) and the estimated state taxes (row 75) from the net income before profit sharing and taxes (row 72). Net operating margins are calculated in row 79 by dividing the estimated net income (row 77) by the total gross sales (row 11). Cash flow from operations is calculated in row 81 by adding the estimated net earnings (row 77) and the depreciation and amortization amount (row 66).

The next section 20, relates to distributions to common and preferred shareholders. Cash distributions to common shareholders are shown in row 83. As shown, there is no distribution to common shareholders in the first year. 50% of estimated net income is distributed in years 2-5. These amounts can be changed by simply changing the percent multiplier applied to the estimated net income.

The cash distribution per common share, line 84, is calculated by dividing the total distribution to common shareholders by the number of outstanding shares. In this case, the number of shares outstanding is 100,000.

Preferred share stated dividends are shown in row 86. Stated dividends per preferred share are shown in row 87. Preferred share participation is shown in row 89, and participation per preferred share is shown in row 90. The calculations for generating these values will be described later when a capitalization plan is described that includes participating preferred stock. For the present purposes of valuing the company, however, these cells are all set to a zero basis by setting the percent participation equal to zero.

Net cash flow from operations is displayed in row 92. The data in these cells are calculated by subtracting the distribution to common shareholders (row 83) from the cash flow from operations.

The next section 22 relates specifically to XYZ Company's capitalization plan which will be described in more detail below. Row 95 indicates the value of common shares sold. Row 96 indicates the amount of capital received from royalty financing contracts. Row 97 shows capital obtained through the sale of participating preferred shares. Row 98 shows capital raised through acquisition of bank debt or note sales, while row 99 shows debt reduction payments by the enterprise to its investor debtors. Rows 95-99 are then added to generate the working capital increase displayed in row 100.

Capitalized assets are listed in the next section 26 of the income statement from row 103 through row 116. Row 117 displays total capitalized assets calculated by summing the values stored in rows 103-116. An initial value is assigned to each capitalized asset in the first year. For example, capitalized organizational costs are estimated to be $180,000 the first year as illustrated in B103 of the income statement, FIG. 2. The organizational costs represent a standard budget with scalable annual increases of 10% reflected in the formula of each year thereafter as illustrated in FIG. 9. The capitalized organizational cost value is shared with the pro form a depreciation and amortization schedule where the cost of the capitalized asset for each year is divided by the number of years over which the asset is amortized to obtain an amortized amount for that year. In the example illustrated in the pro form a depreciation and amortization schedule of FIG. 6, the organizational costs are amortized over a five-year period (A7); therefore, the organizational costs for each year are divided by five. The second half of the worksheet, columns H-M, illustrate the summation of the amortized amount for that year with the amortized amount for each previous year to obtain a total amortized amount for that year (rows 7-11). The total amortized or depreciated amount for each capital asset is accumulated into a total depreciation amortization amount for each year (income statement, row 117). This total depreciation amortization amount is then transferred back to row 66, of the income statement where it is used to determine other generated data such as the cash flow from operations (row 81).

Estimated net earnings per share are calculated and displayed in row 119. The net earnings per share are calculated by dividing the estimated net income (row 77) by the number of authorized shares.

The final section 26 of the pro form a income statement and company valuation worksheet of FIG. 2 shows the results of the company valuation and the internal rate of return (IRR) for the various deal structures comprising the capitalization plan. Row 121 lists the estimated value of the XYZ Company per share loosely based on a more or less arbitrarily selected price to earnings ratio (PE ratio) characteristic of a particular industry in a private market. In the example shown, the PE ratio selected is three. The estimated private market value per share is calculated by multiplying the estimated earnings per share by the PE ratio. Row 122 displays the total private company valuation. This value is obtained by multiplying the estimated private market value per share (row 121) by the total number of authorized shares. Rows 123-126 show the internal rates of return (IRR) for various deal structures. Row 123 shows the IRR for a debt with equity kicker deal structure. Row 124 shows the IRR for a royalty financing deal structure. Row 125 shows the IRR for a participating preferred stock deal structure and row 126 shows the IRR for a deal structure including the sale of common stock shares. These deal structures will be described in more detail below in the example of an integrated hybrid capitalization plan for the XYZ Company. The IRR values in rows 122-126 are taken directly from the IRR worksheet (FIGS. 8 and 15).

The pre-loaded values initially entered into the pro form a financial projections templates are for the purposes of illustration. A new user of the invention is encouraged to generate hypothetical capitalization plans using the supplied data in order to learn how the software operates and to become comfortable using the software. Once the user is comfortable with the worksheets, he or she may then change the supplied values to more accurately reflect the operating circumstances of the enterprise. From there, the user may go on to generate as many different capitalization plans for the enterprise as desired. For purposes of the present example, however, the user will proceed with the values provided.

In determining the total capital requirements of the enterprise, it is assumed that the company has raised no capital. This is reflected in the capitalization section of the income statement, FIG. 2 rows 95-99, where each row has a zero value entered in each cell indicating there have been no common shares sold, no royalty financing contracts sold, no participating preferred shares sold, no bank debt acquired or notes sold, and no debt reduction payments made. Based on all of the other financial projections that have been provided in the income statement, the capital needs of the enterprise can easily be determined by viewing the deficit figures in row 31 of the corresponding pro form a statement of cash flows illustrated in FIG. 4.

All of the worksheets are linked so that data flow from one worksheet to another. Changes to and assumptions made in one worksheet are automatically reflected in the other worksheets. Thus, the data from the income statement described above will impact the cash flow numbers depicted in the pro form a statement of cash flows (FIG. 4). From the year-end cash and equivalents, the user can determine the capital requirements of XYZ Company for the first five years to ensure that the company will have sufficient funds available to meet its financial obligations. Again, as illustrated in FIGS. 2-8, the pro form a financial projections worksheets reflect a cash position where XYZ Company has raised no capital. Referring to FIG. 4, row 31 of the pro-form a statement of cash flows, for each of the first three years of operations, the first year deficit is $1,971,958 (B31). The second year deficit is $3,726,090 (C31), and the third year deficit is $1,546,123 (D31) for a total deficit of nearly $7 million.

Not until the fourth year does the company see positive cash flow of $2,191,848 (E31), and $6,145,516 in the fifth year (F31). Of course, the company must survive into years four and five in order to experience these positive cash flows. Without supplementing the cashflow shortfalls in the first three years, the projected positive cash flows of years four and five will never be realized.

While the total deficit from the first three years is nearly $7 million, this does not necessarily represent the total amount of capital necessary to fund XYZ Company, as will be demonstrated below.

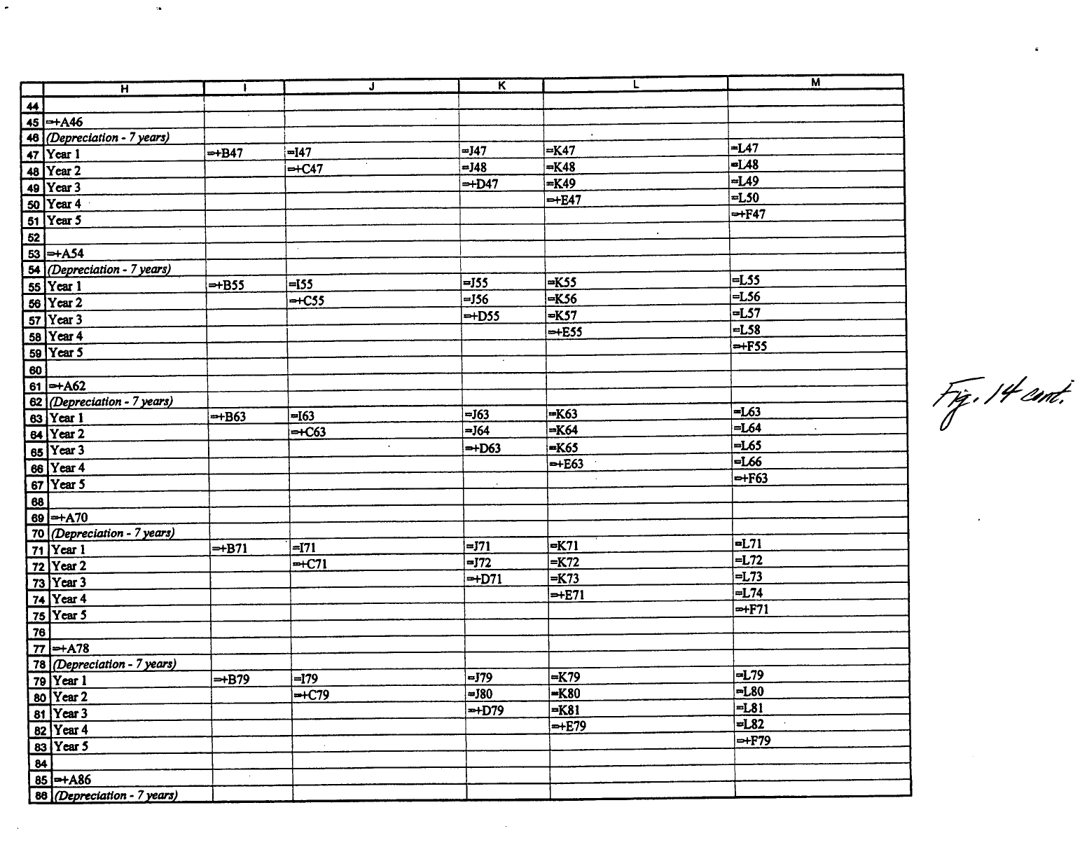

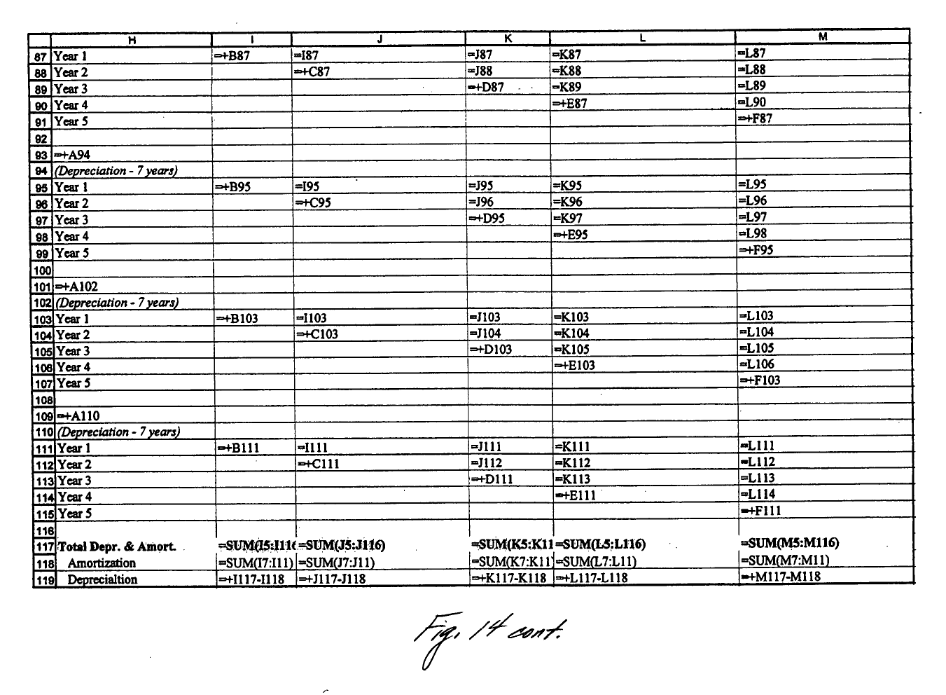

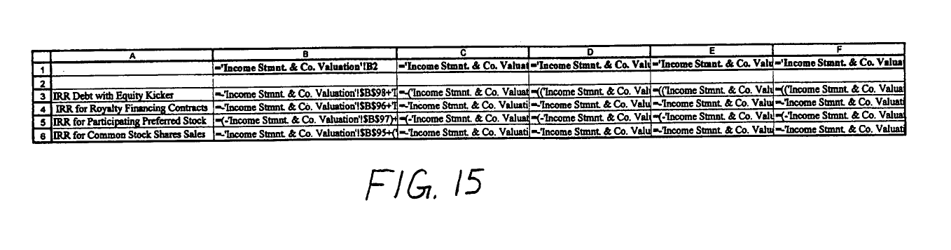

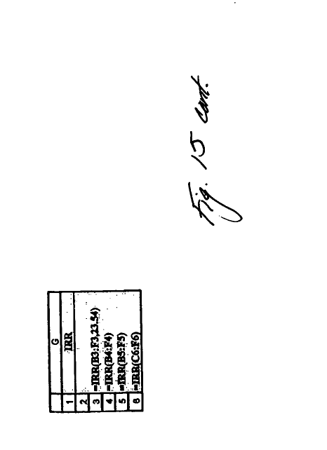

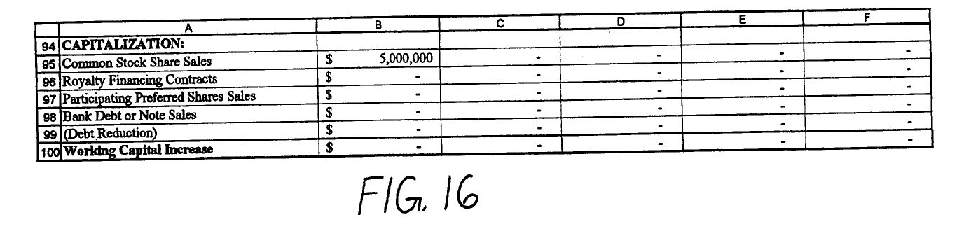

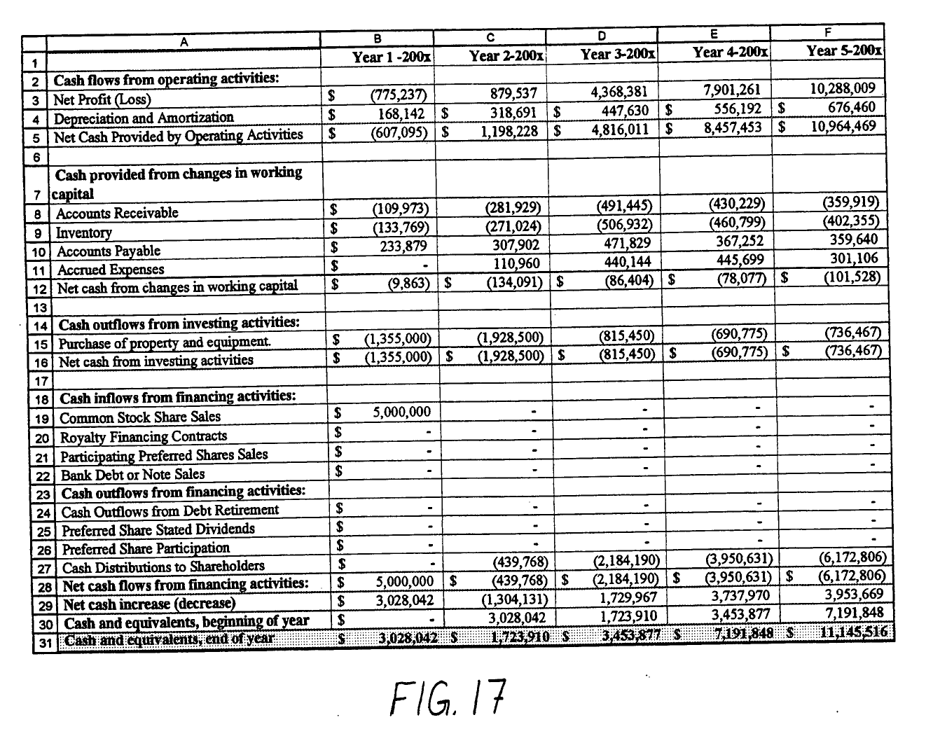

The next step is to formulate a capitalization plan to meet the capital needs of the enterprise. This includes considering some straightforward deal structures for raising capital to fund XYZ Company and to determine how much capital is actually necessary to sustain XYZ Company through the first three years. Ultimately, the deal structures for the capitalization plan must be attractive to potential investors, otherwise investors will be unwilling to provide the necessary capital. First, the user will consider the sale of common shares XYZ Company for purposes of raising capital. The user will assume $5,000,000 can be raised through the sale of common shares. Accordingly, $5,000,000 is entered in cell B95 of the income statement as shown in FIG. 16. Returning to the cash equivalents available at the end of each year in row 31 of the pro form a statement of cash flows in FIG. 17, the infusion of capital from the sale of common shares allows XYZ Company to have a positive cash flow in each of the first five years of the capitalization plan. In fact, even in the second year, the leanest of the first 5 years of the plan, XYZ Company still has $1,723,910 on hand. Thus, raising the $5,000,000 in the first year is more than enough to carry the enterprise through its start-up stage. In this case, the user may wish to reduce the $5,000,000 stock sale to determine whether a lower amount of initial funding will provide sufficient cash flow for the operations of the enterprise.

In FIG. 18, the $5,000,000 common stock sale has been replaced with a $4,000,000 common stock sale. This change is reflected in row 31 of the pro form a statement of cash flows worksheet shown in FIG. 19. Here the user can conclude that XYZ Company still has positive cash flow at the end of every year. Accordingly, raising only $4,000,000 in the first year will still be sufficient to sustain the business. The company may not want to settle for less than $4,000,000, though, since the cash on hand at the end of the second year is dwindling and the company may want to have some degree of cushion to deal with unforeseen events.

Next, the user can consider the internal rate of return (IRR) on the $4,000,000 invested in XYZ Company to determine whether such a deal structure would be attractive to investors. First, it must be noted that the present example assumes 100,000 common shares authorized by XYZ Company (see, for example, the estimated private market value per share calculation or the cash distributions per share calculation rows 121 and 84 of the income statement worksheet of FIG. 2.) Further, the user can assume that the $4,000,000 was raised through the sale of 40,000 of the 100,000 shares authorized. The five year IRR for this investment (not shown) is only 6.82%. 6.82% may represent too low of a return for the amount of risk inherent in investing in a start-up company. Therefore, this deal structure may not be attractive to investors.

One way to increase the IRR is to increase the number of shares sold. Simply changing the number of shares included in the deal can dramatically change the IRR. However, a disadvantage to increasing the number of shares in the deal structure is that selling more shares means selling a greater stake in the company. For example, by selling 70,000 shares of the 100,000 authorized shares, the IRR can be increased to 27.2%. Unfortunately, this IRR may still not be a sufficient return to attract capital. Furthermore, the deal structure requires selling a controlling interest in the company and dilutes the investors' investment by 30%. (70,000 shares−100,000 authorized shares=−30,000 shares/100,000 shares=−30%) Clearly, this deal structure could be unsatisfactory to both the company founder and its investors. Another approach may be needed to attract capital to find the business and maintain the founders' control over the business.

A solution to a low IRR and losing a controlling interest in the enterprise could include formulating a number of hybrid deal structures and a number of different securities offerings at different phases of the development of the enterprise. A major benefit of the linked worksheets described above is that the worksheets can be employed to create and test multiple finding scenarios so that a user can develop one or more capitalization plans without changing fixed and assumed values in the capitalization plan. Each capitalization plan can then include one or more deal structures tailored to particular investors in the capital markets.

In an embodiment of the present invention, the pro form a financial projections template initially supplied to the user includes a capitalization plan that includes standard deal structures, such as the common stock share sale or bank debt or note sales, as well as hybrid deal structures, such as royalty financing contract sales, participating preferred share sales, and a debt with equity kicker deal structure, also known as Unit sales. The various deal structures of the capitalization plan may be implemented independently or in various combinations to meet the particular requirements of a specific enterprise. The deal structures may be customized or tailored to make the deals as attractive to the investment community as possible.

For purposes of illustration, the five year capitalization plan described below includes multiple rounds of funding using more than one deal structure. It should be kept in mind, however, that other capitalization plans using different deal structures and combinations of deal structures are also possible depending on the needs of the enterprise and the returns sought by investors. In fact, one of the benefits of the present invention is that such alternative capitalization plans can be generated and the strengths and weaknesses of the capitalization plans be compared in a reasonably simple and efficient manner.

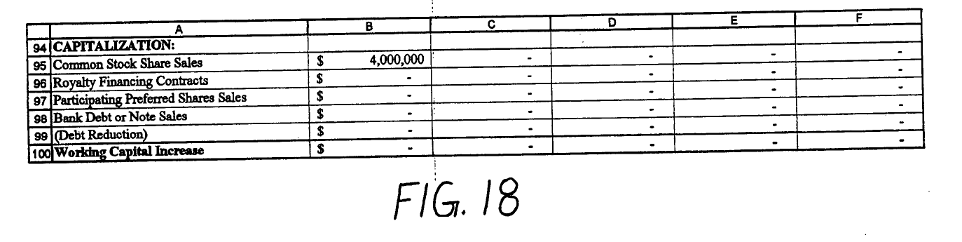

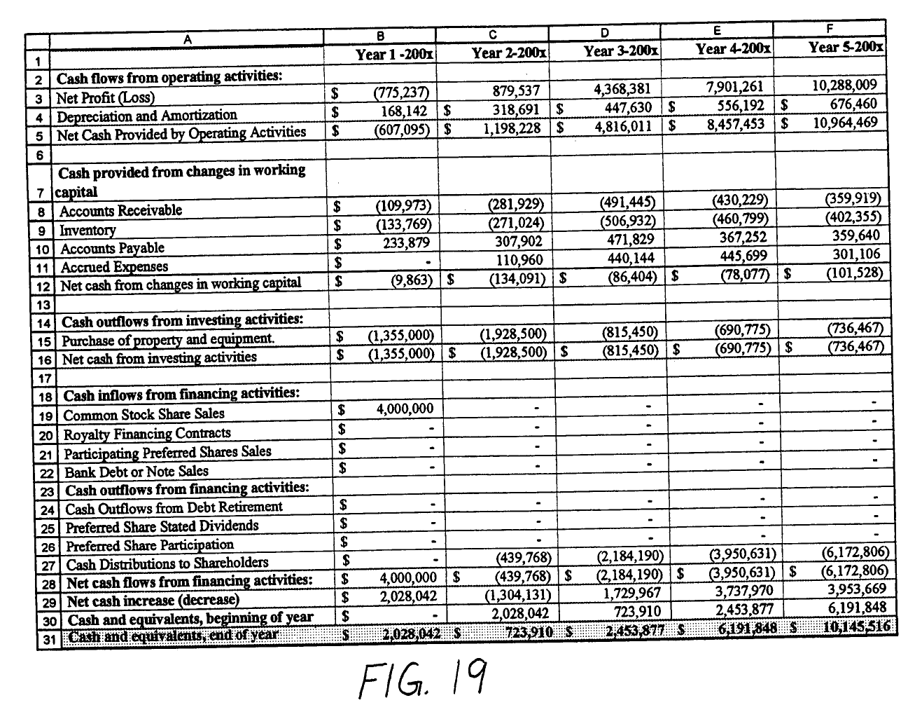

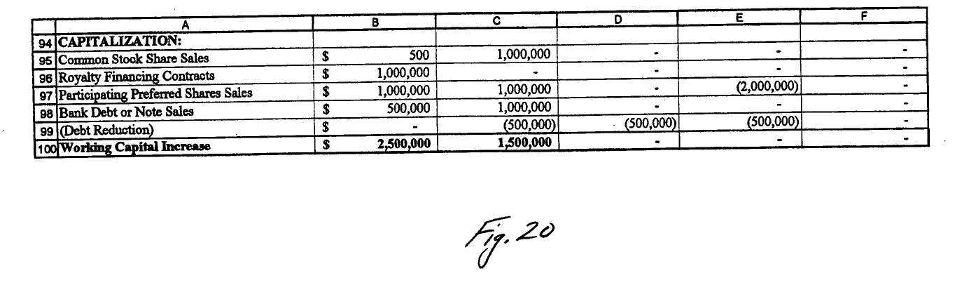

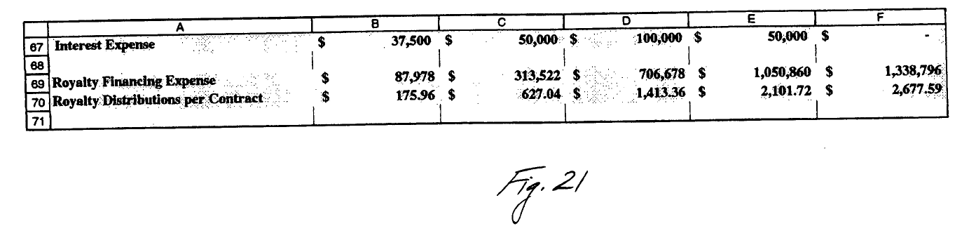

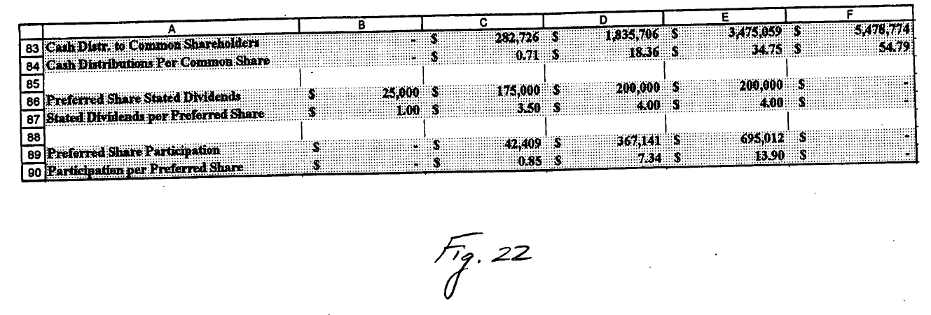

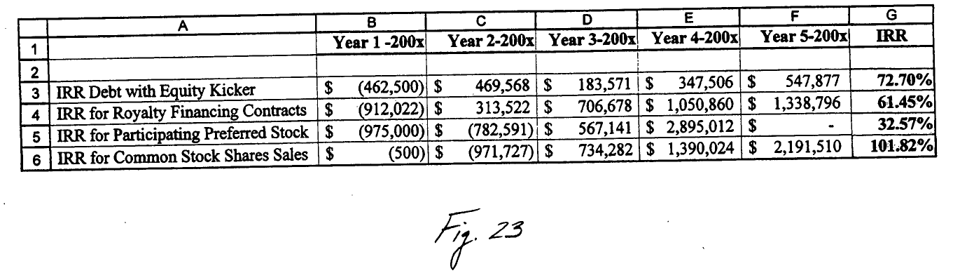

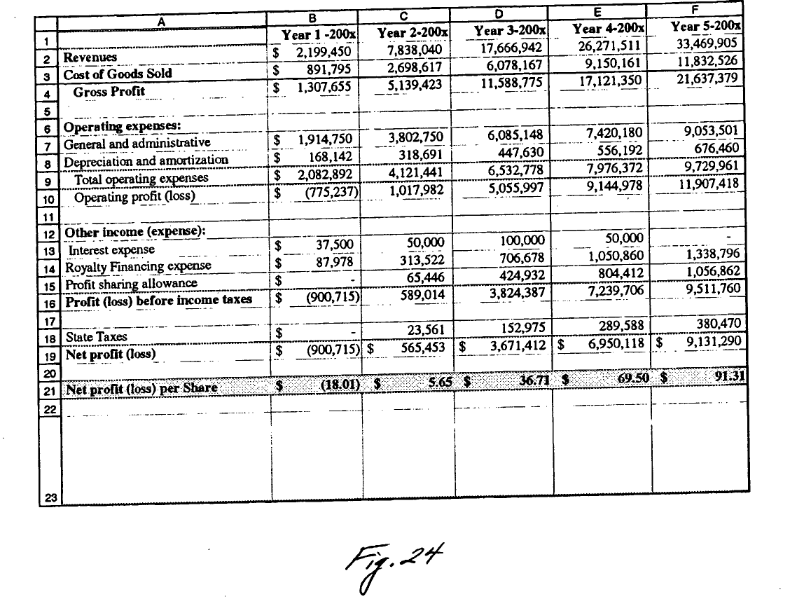

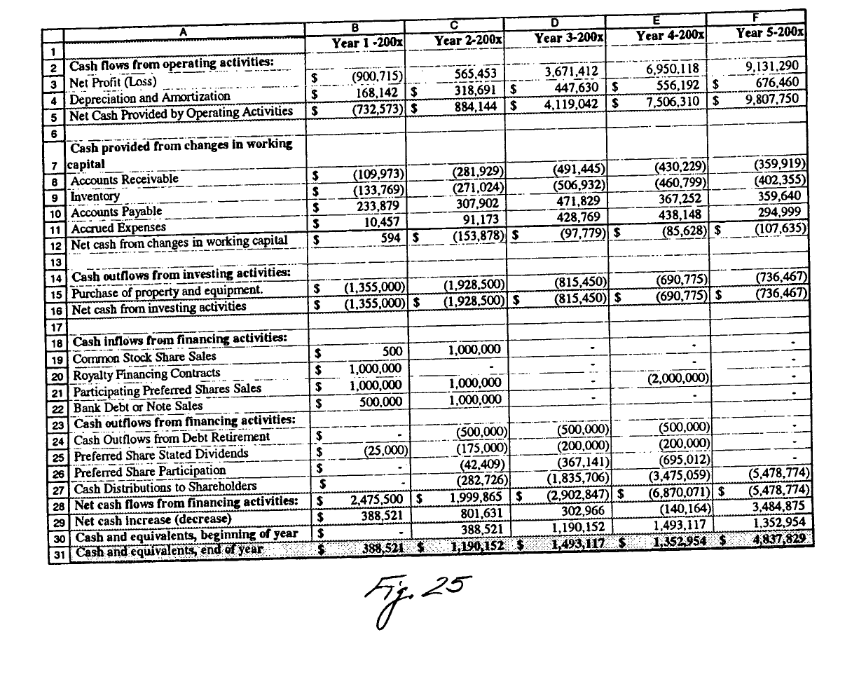

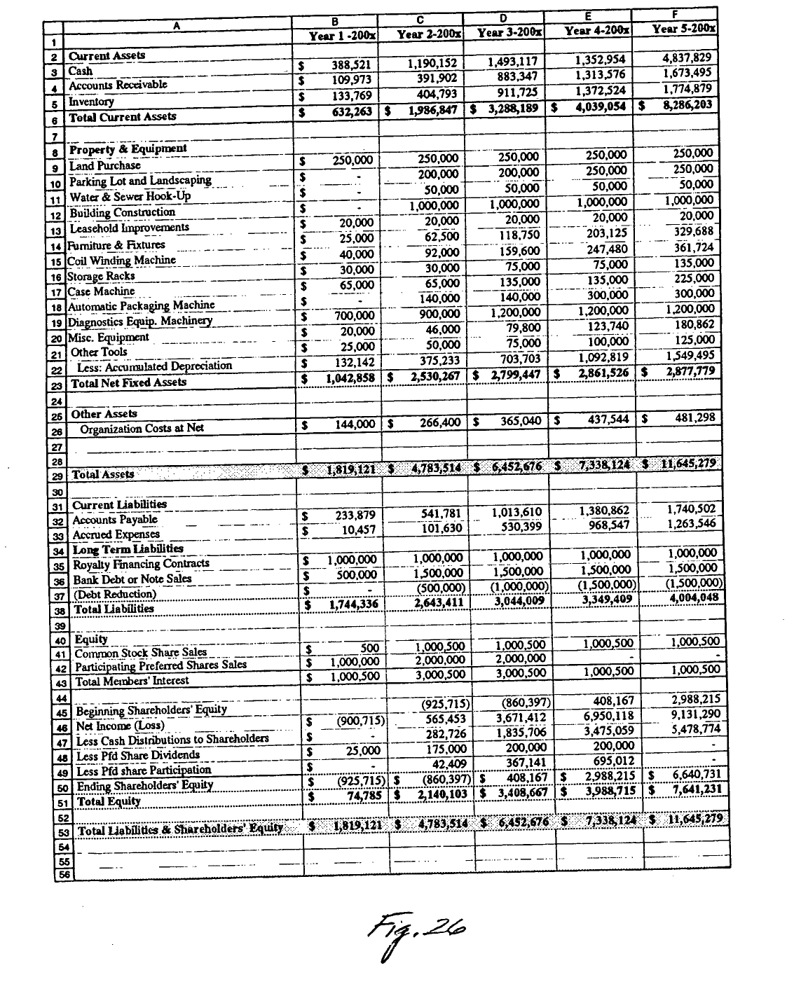

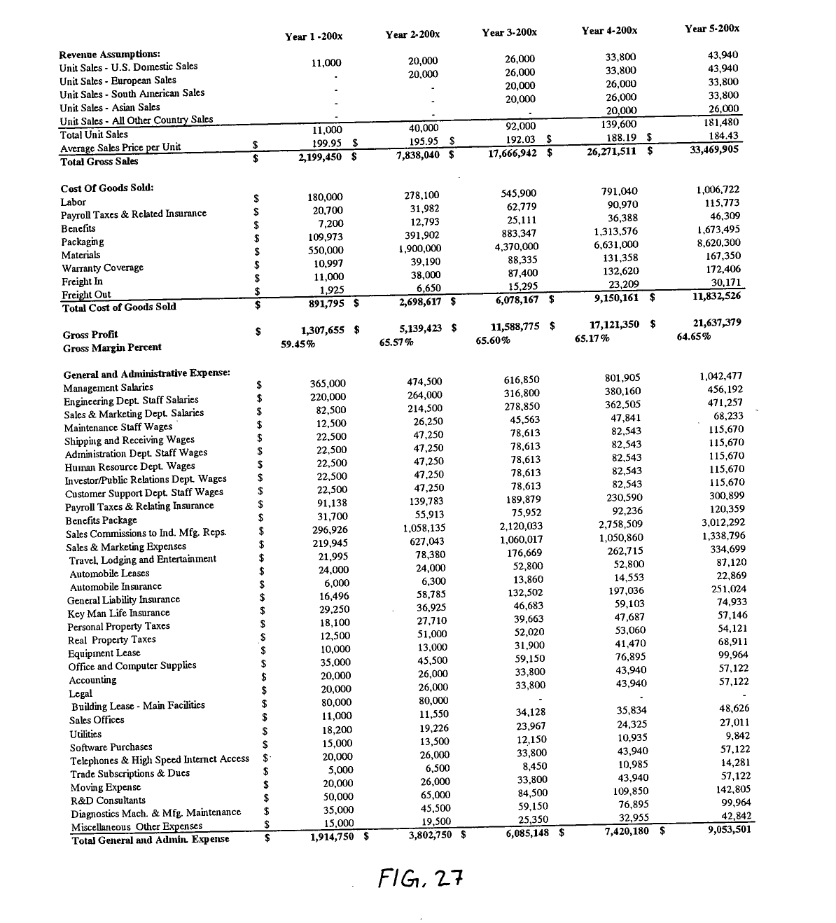

FIGS. 20-26 illustrate the pro form a financial projections worksheets for a complete five-year, multi-round capitalization plan for XYZ Company. All of the financial assumptions regarding the performance of the enterprise (total gross sales, total cost of goods sold, gross profit, gross profit margin, net operating profit, estimated net income, net operating margins, cash flow from operation, total capitalized assets, and the like) are the same as they were when the enterprise's capital requirements were determined. For purposes of the present discussion, however, only those portions of the pro form a financial projections affected by the capitalization plan will be illustrated. The only data in the cells that are different are those that relate to the various deal structures for implementing the five-year comprehensive capitalization plan. The details of the comprehensive capitalization plan are embodied in rows 94-100 of the income statement shown in FIG. 20. Other portions of the income statement related to the capitalization plan include interest expense, royalty financing expense and royalty distribution per contract as shown in rows 67-70 of FIG. 21; distributions to common and preferred shareholders as shown in rows 83-90 of FIG. 22; and the IRR for each of the various deal structures as shown in FIG. 23. As discussed above, the capitalization plan will also impact other worksheets such as the pro form a statement of operations as shown in rows 13-14 of FIG. 24, the pro form a statement of cash flows as shown in rows 18-27 of FIG. 25 and the pro form a balance sheet as shown in rows 34-53 of FIG. 26.

The comprehensive capitalization plan includes first round financing for raising seed capital. The first round is known as debt with an equity kicker. $500,000 is to be raised by the sale of $10,000 first mortgage notes with a 10% coupon. Each note includes a single share of common stock sold at a discount price of $0.05 per share. Thus, the total proceeds to the company from the sale of the notes and the equity kicker total $500,500. This capital infusion can be seen on the pro form a income statement in cells B95 and B98 of FIG. 20 representing first year common stock share sales and bank debt or note sales, respectively. Interest paid on the notes is prorated in the first year, and paid in full in the second. These are payments to the investors and are shown as interest expenses in row 67, columns B and C of the income statement of FIG. 21. The interest is paid only for the first two years because the notes are to be paid off at the end of the second year. The debt reduction payment is entered in row 99 of the second year, column C, of the income statement of FIG. 20.

The present invention enables the user to determine the return to investors who buy the notes with the equity kicker. Turning to the IRR worksheet, FIG. 23, row 3 represents the annual returns for investors who buy into the debt with equity kicker deal. The first year, column B, appears as a negative value representing money from investors to purchase the debt notes and common share equity kicker. This value also includes the interest payment of $37,500 paid to the investor at the end of the first year. In the second year, column C, the principal is repaid plus 10% interest on the notes and the distribution for the 10,000 shares of common stock comprising the equity kicker. Because the principal is repaid in the second year, no more interest is paid on the notes so the returns for years three, four and five are based solely on the equity kicker. In year three, column D, the distribution to common shareholders is determined to be $18.36 per share. Multiplying this per share distribution figure by the 10,000 shares in the equity kicker issued with the debt notes, equals $183,571. Similar calculations result in a return of $347,506 in year four and $547,877 in year five. The total IRR for the debt with equity kicker deal structure for the first five years of operation is 72.70%.

The second round development capital fundraising of the illustrated example comprises $1,000,000 in royalty financing contracts. The money coming into XYZ Company from the royalty financing contracts is shown in cell B96 of the income statement of FIG. 20.

Returning to the IRR worksheet in FIG. 23, the estimated IRR for the royalty financing contracts deal structure is calculated as follows. The return to the investor for each of the first five years is shown in row 4. The first year entry, column B, is calculated by representing the $1,000,000 initial investment paid by the investor in column B, row 96 of the income statement of FIG. 20 as negative cashflow and adding the royalty financing expense in cell B69 of the income statement of FIG. 21 paid by the company to the investor in the first year. The royalty contracts of this example require XYZ Company to pay 4% of gross sales ($2,199,450 as illustrated in cell B11 of the income statement of FIG. 2) to the investor each year. Thus, the total first year payment to royalty finance contract holders is $87,978. This amount added to the $1,000,000 paid by the investors results in a first year total return of −$912,022 as illustrated in cell B4 of the IRR worksheet of FIG. 23. In the second year, royalty financing contract holders receive $313,522, in the third year, $706,078, in the fourth year, $1,050,860 and, in the fifth year, $1,338,796 for a total IRR of 61.45%.

Third round fundraising for raising expansion capital in the illustrated example comprises the sale of participating preferred shares. It is anticipated that the user will sell $1,000,000 worth of preferred shares in the first year, and another $1,000,000 worth of preferred shares in the second year. All of the preferred shares are redeemed in the fourth year. Thus, row 97 of the income statement of FIG. 20 shows positive preferred share sales of $1,000,000 in both the first and second years of the capitalization plan and a call back of the $2,000,000 worth of shares in the fourth year. The estimated IRR for the participating preferred stock is calculated in row 5 of the IRR worksheet. The first year entry, column B, includes the $1,000,000 paid by investors (expressed as a negative value since it represents outgoing funds from the perspective of the investor), plus the first year preferred share stated dividend in cell B86 along with the preferred share participation in cell B89 of the income statement of FIG. 22. In this example, the first year participating preferred share stated dividend is $25,000 and the first year preferred share participation is $0. Therefore, the first year total return to participating preferred shareholders is −$975,000 as illustrated in cell B5 of FIG. 24. In the second year, participating preferred shareholders pay an additional $1,000,000 to XYZ Company. The preferred share stated dividend in cell C86 of the income statement of FIG. 22 is $175,000 and the preferred share participation in cell C36 of the income statement of FIG. 22 is $42,409. Thus, the second year total return for the participating preferred shareholders is −$782,591 as illustrated in cell B5 of FIG. 23. In year three, the preferred share stated dividend is $200,000 as illustrated in cell D86 of the income statement of FIG. 22 and the preferred share participation as illustrated in cell D89 of the income statement is $367,141, for a total of $567,141. In year four, the participating preferred share stated dividend as illustrated in cell E86 of the income statement is again $200,000, and the participating preferred share participation as illustrated in cell E89 of the income statement is $695,012. Additionally, the participating preferred shares are redeemed. Thus, the participating preferred shareholders' original $2,000,000 investment is redeemed or returned to the investors in year four. Thus, the total amount paid to participating preferred shareholders in year four is $2,895,012. Nothing is paid to these investors in year five. Thus, the total IRR for the participating preferred stock investors is 32.57%.

Finally, the example capitalization plan calls for fourth round equity capitalization for raising expansion capital. This round envisions the sale of 40,000 common shares from among the 100,000 common shares authorized at a share price of $25.00 per share, for an additional $1,000,000 of funding. The results of this fourth round of funding are shown in cell C95 of the capitalization section of the income statement of FIG. 20. The IRR for common shareholders is calculated in row 6 of the IRR worksheet of FIG. 23. The first year entry, column B, reflects the $500 raised via the equity kicker portion in the debt with equity kicker deal structure described above. The second year entry, column C, includes the $1,000,000 paid by investors for the additional 40,000 shares, and is expressed as a negative value since this is money paid out by the investors. The second year value also includes the dividend paid to common share holders in the second year. This is calculated by multiplying the cash distributions per common share (cell C84 of the income statement) by the number of shares sold, i.e., 40,000. Thus, the total dividend for common shareholder paid in year two is $28,400. The common shareholders' total return for year two is −$971,727. In year three, the common shareholders' total return is $734,282, $1,390,024 in year four and $2,191,510 in year five. This results in an internal rate of return of 101.82%.

In addition to the internal rate of return calculations shown in FIG. 23, the impact of the capitalization plan can be seen in the pro form a statement of operations, statement of cash flows and the pro form a balance sheets, all shown in FIGS. 24, 25 and 26, respectively. As can be seen in row 31 of the statement of cash flows, the capitalization plan provides adequate funding for operations in each of the first five years of the plan. What is more, the internal rate of return for the various deal structures are fairly attractive and would likely attract investor attention.

There are an unlimited number of ways to structure a capitalization plan. An enterprise can mix and match any number of deal structures to accomplish its funding requirements. It should be clear that an entrepreneur using the series of linked pro form a financial projections worksheets described above can easily experiment with different deal structures and test different capitalization plans to determine which capitalization plan produces the appropriate deal structures that are most suitable for the enterprise.

In addition to providing the interlinked pro form a financial projections worksheet templates, the present invention further encompasses providing document templates for preparing the notes to the pro form a financial projections and for preparing private placement memoranda for the various securities offerings that will form the basis of the actual capital raising efforts. Appendix A of the present specification shows a sample template for the notes to the pro form a financial projections. Appendix B shows a coversheet and table of contents template for a private placement memorandum for the debt with equity kicker deal structure described above. Appendix C shows a coversheet and table of contents template for a private placement memorandum for a royalty financing contract offering as described above. Appendix D shows a coversheet and Table of Contents for a participating preferred stock offering as described above, and Appendix E shows a cover sheet and Table of Contents template as part of the equity capitalization plan described above.

Finally, Appendix F includes an entire private placement memorandum template for the debt with equity deal structure described above. Private placement memoranda for other deal structures are also provided to the user in an embodiment of the invention, but such additional memoranda templates are not included with the present specification due to the cumulative nature of such documents. It will be readily apparent to those skilled in the art that the template in Appendix F can be easily adapted to serve as a private placement memorandum template for other capitalization deal structures.

As the user steps through the pro form a financial projections worksheets to build a unique capitalization plan, he or she is instructed to simultaneously edit the corresponding note to pro form a template so that the notes will accurately reflect the various financial assumptions and deal structures that embody the enterprise specific capitalization plan that is ultimately developed. The same holds true for private placement memoranda templates. As the user develops a capitalization plan that incorporates a specific deal structure, the user must choose and edit the private placement memorandum template corresponding to the chosen deal structure so that the final document accurately reflects the particular terms of the selected deal structure.

Upon completing the pro form a financial projections worksheets, the notes to pro formas and the corresponding private placement memoranda, the user has taken several large steps in a successful capital raising effort. At this point, the user is advised to visit financial professionals to solidify his or her plan. Professional services are still required to implement the plan, but by doing most of the background work ahead of time, the user greatly reduces the amount of fees which would otherwise be required to pay for such services.

It is also possible for the user to put together several well-packaged capitalization plans to shop around to various investors to see in which types of deal structures those with capital are interested in investing. Based on the results of such “red herring” documents, the user can select the capitalization plan that sparked the most interest and move forward from there.

Thus, the present invention greatly simplifies the process of raising capital for entrepreneurs and small start-up businesses. The invention reduces the costs of raising capital and frees resources for use in expanding the business.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of reducing the cost of raising capital, the method comprising the steps of:
providing a mechanism whereby an enterprise can test at least one deal structure to determine a deal structure that is optimal for the circumstances of the enterprise, said deal structure including at least one capitalization variable; and
providing at least one template document presenting the determined deal structure and the capitalization variable.

2. The method of claim 1, wherein the mechanism includes associating a plurality of interconnected worksheets with the template document, wherein input data entered into at least one worksheet is used to determine information provided in said template document.

3. The method of claim 2, wherein data input into one worksheet is transferred to at least one other worksheet.

4. The method of claim 2, wherein data input into one worksheet is used to generate other data.

5. The method of claim 4, which includes applying a formula to the input data to produce the generated data.

6. The method of claim 2, which includes determining an estimated capital need based on the data input into the worksheets.

7. The method of claim 6, which includes applying at least one deal structure to the estimated capital need determined in the worksheets.

8. The method of claim 6, wherein determining an optimal deal structure is based on reducing the capital need and providing a desirable estimated investment outcome.

9. The method of claim 8, wherein the estimated investment outcome is calculated based, at least in part, on the capitalization variable of the deal structure.

10. The method of claim 8, wherein the estimated investment outcome includes an estimated internal rate of return.

11. The method of claim 8, wherein determining an optimal deal structure is based on a level of risk associated with the estimated investment outcome.

12. The method of claim 1, wherein determining an optimal deal structure is based on providing a desirable amount of working capital.

13. The method of claim 1, wherein providing at least one template document includes providing a plurality of securities offering documents.

14. A method allowing an enterprise to prepare capitalization plan documents to raise capital, the method comprising the steps of:
providing a plurality of template documents having variable data to be determined, each template document having at least one worksheet associated therewith;
gathering information from the enterprise on said worksheet including estimated capital need and at least one deal structure;
calculating an estimated investment outcome based, at least in part, on the information gathered from the enterprise; and
determining the deal structure that meets the capital need and provides the optimal balance of risk and estimated investment outcome to the investor.

15. The method of claim 14 which includes calculating the variable data necessary to complete the template document based on the capital need, deal structure and estimated investment outcome.

16. A system of producing a capitalization plan comprising:
a first template worksheet interconnected with a second template worksheet such that input data and generated data in said first and second worksheets can be transferred between said first and second worksheets;
a plurality of data cells in each of said first and second template worksheets, wherein the input data is entered into said data cells;
a plurality of formulas associated with said data cells, wherein said formulas are adapted to calculate the generated data from the input data entered into said data cells;
at least one deal structure, said deal structure including at least one capitalization variable, wherein said capitalization variable is entered into at least one worksheet, and generated data is calculated based on said capitalization variable to determine an investment outcome; and
a document template which presents the deal structure.

17. The system of claim 16, wherein the capitalization variable includes an amount of capital represented by equity.

18. The system of claim 16, wherein the capitalization variable includes an amount of capital represented by debt.

19. The system of claim 16, wherein the capitalization variable includes an amount of capital represented by royalty contracts.

20. The system of claim 16, wherein the investment outcome includes an internal rate of return.

21. The system of claim 16, wherein the document includes a private placement memorandum.

22. A method of preparing financial documents for raising capital, the method comprising:
providing a mechanism for an enterprise to efficiently explore a plurality of different deal structures for raising capital;
allowing a user to test various deal structures based on circumstances of the enterprise;
allowing the user to select one or more deal structures to create a capitalization plan; and
prepare documentation to support the one or more deal structures forming the capitalization plan.

23. The method of claim 22 wherein said step of providing a mechanism for the enterprise to efficiently explore a plurality of different deal structures comprises:
providing a plurality of linked spreadsheet templates for preparing pro form a financial projections.

24. The method of claim 22 wherein the step of preparing documentation to support the one or more deal structures comprises:
preparing at least one of, pro form a financial projections, notes to pro form a financial projections, a private placement memorandum, and SEC filing documents.
